(19) United States
(12) Patent Application Publication
(10) Pub. No.: US 2025/0223501 A1
(43) Pub. Date: Jul. 10, 2025

(54) PLASTIC UPGRADING USING POISON RESISTANT CORE-SHELL CATALYSTS

(71) Applicant: Anellotech, Inc., Pearl River, NY (US)

(72) Inventors: Zhihua Wu, Pearl River, NY (US); Torren Carlson, Newark, DE (US); Omar Basha, Wilmington, DE (US); Leslaw Mleczko, Dormagen (DE)

(21) Appl. No.: 19/014,075

(22) Filed: Jan. 8, 2025

Related U.S. Application Data
(60) Provisional application No. 63/619,115, filed on Jan. 9, 2024.

(51) Int. Cl. C10G 1/10; B01J 23/02; B01J 29/06; B01J 29/90; B01J 35/30; B01J 35/53

(52) U.S. Cl. CPC C10G 1/10; B01J 23/02; B01J 29/06; B01J 29/90; B01J 35/395; B01J 35/53; C10G 2300/1003; C10G 2300/4006; C10G 2300/4012; C10G 2300/4081; C10G 2300/4093; C10G 2300/701; C10G 2300/703; C10G 2400/20; C10G 2400/30

(57) ABSTRACT

A process for upgrading plastics to olefins, paraffins, and aromatics with a core-shell catalyst in a fluidized bed reactor is described.

### FIELD OF THE INVENTION

This invention relates to methods and apparatus using core-shell catalysts that resist poisoning for the upgrading of polymeric hydrocarbonaceous materials in the catalytic pyrolysis of waste plastics, or polymers or other waste materials to valuable chemical and fuel products such as paraffins, olefins, and aromatics.

### RELATED APPLICATIONS

This application claims the priority benefit of U.S. Provisional Patent Application Ser. No. 63/619,115 filed 9 Jan. 2024, which is incorporated herein as if reproduced in full below.

### INTRODUCTION

Catalytic processes for upgrading plastics, or waste streams of all types suffer from the presence of impurity elements in the feed streams that can poison or inhibit the activity of the catalysts. Catalyst activity is conventionally regenerated by removing coke and other carbonaceous deposits by combustion with air. Conventional oxidative regeneration does not, in general, remove other impurities, particularly metals such as Na, K, Ca, Mg, etc., that build up on the catalyst with time on stream and reduce catalyst activity and/or selectivity.

Zeolite catalysts are frequently chosen for upgrading of polymeric materials such as plastics, or waste materials due to their unique combination of pore structure and catalytic active acid sites. Plas-TCat™ is a catalytic fluid bed process using zeolite catalysts to chemically recycle polymer/plastic material. These processes are suitable for waste plastics that otherwise might be sent to a landfill or incinerator. The zeolite catalysts used for these processes are microporous solid acid materials that are active for the upgrading of the primary products of plastics decomposition, converting them to a mixed product of permanent gases, C2-C4 light olefins, C1-C4 light paraffins, and C5+ hydrocarbons including benzene, toluene, and xylenes (BTX), other aromatics, non-aromatic naphtha range molecules, C11+ hydrocarbons, coke and char, and minor byproducts. Mineral elements often are deposited on the catalyst surface and/or in the catalyst pores.

When coke, char, and minerals build up on the catalysts, reducing activity and selectivity to valuable products, they can be regenerated. Conventional means of regenerating catalysts from the catalytic pyrolysis of hydrocarbonaceous materials involve the combustion of carbonaceous materials that remain on the surface or in the pores of the catalyst, so that the catalyst can be returned to the catalytic pyrolysis reactor. Similar methods are used to regenerate catalysts from fluid cat cracking (FCC), hydrotreating (HT), and other refining or chemical processes.

Halogens, minerals, and metallic elements present as contaminants in polymeric materials, such as chloride in PVC and other plastics, present a challenge to catalytic processes. These elements can deactivate the catalyst, interfere with the smooth operation of a catalytic pyrolysis process by several mechanisms, or corrode the catalyst structure or metallic reactors. The effect of these contaminants can be reduced by removing them from the feed to very low levels, or by regular removal of them from the catalyst, or both, to improve catalyst life. Processes for preventing contamination of catalysts by impurities include washing or otherwise pretreating the feed(s) to remove the contaminants before the catalytic processing step, as described in United States Patent Application Pub. 2017/0002270. In some cases, pretreatment of feeds may not remove the contaminants to an acceptable level such that the improvement in catalyst activity and/or life is limited. Catalyst rejuvenation by removing the offending impurity elements from the used catalyst is also possible and could be used in addition to oxidative regeneration that removes carbon.

Various extraction techniques have been proposed that can be applied to catalysts either before or after oxidative regeneration. Processes for removing impurity elements from catalysts that have been contaminated by impurity elements include those in United States Patent Application Pub. 2014/0303414. Such catalyst washing techniques are often effective at removing contaminants, but in some cases do not remove enough of the contaminants to fully restore catalyst activity and selectivity to that of the fresh catalyst or can remove additional components from the catalyst. These processes do not entirely solve the problem as contaminants are still present in the process, and catalyst activity still declines with time on stream and exposure to feed, albeit more slowly. Unfortunately, these processes may result in other impacts on the catalyst such as removal of critical catalyst promoter elements, redistribution of catalyst elements, or modification of catalyst structure(s).

Core-shell catalysts provide another means of limiting the impact of impurities on catalyst activity by preventing contaminants from reaching the catalytically active sites. Together with feed pretreatment and post-reaction catalyst washing, the use of core-shell catalysts for upgrading polymeric materials presents an effective strategy for maintaining catalyst activity.

Core-shell catalysts have been reported to protect active sites against carbon deposition and catalyst poisoning in methane steam reforming (Jeon, K-W, et al. Chemical Engineering Journal 454 (2023) 140060) for molten carbonate fuel cell (MCFC) applications. The core-shell catalysts were more active initially due to smaller Ni particle sizes, but “regardless of alkali poisoning, the TOF decreased exponentially” as the Ni particles sintered.

Zhang et al (J Zhang, X. Zhang, W. Liu, H. Liu, J. Qiu, K. L. Yeung, J. Power Sour. 246 (2014) 74-83) showed that a core-shell steam reforming catalyst with a Ni/Al2O3core and a mesoporous silica shell at least 3.5 microns thick was stable to potassium-containing vapor at 700 C for 120 hours and calculated that a shell thickness of 14 microns would provide protection against alkali poisoning for 250 hours under steam reforming conditions (600-700° C.) of direct reforming molten carbonate fuel cells.

United States Patent Application 2019/0092644 discloses processes for making catalysts with a core-shell structure wherein the core material was silicate, aluminum silicate, vanadium silicate, iron silicate, silicon-aluminum phosphate (SAPO), or aluminum phosphate (AIPO) and the shell material was layered double hydroxide. The patent does not mention the application of the catalysts in any production processes.

United States Patent Application 2021/0322961 to PTT Global Chemical Company Ltd. discloses a process for producing light olefins from C4-C7 hydrocarbons by catalytic cracking using a catalyst with core-shell structure comprising a zeolite core with mole ratio of silicon to aluminum (Si/Al) between 2 to 250 and layered double hydroxide shell. U.S. Pat. No. 11,311,866 to Saudi Arabian Oil Co. describes cracking catalysts which incorporate a platinum nanoparticle encapsulated by a microporous SiO2 layer molecular sieve, wherein the Pt particle provides hydrogen for the hydrogenation and hydrocracking of heavy hydrocarbons with improved sulfur tolerance.

Al-Khattaf et al of King Fahd University in United States Patent Application 2018/0280954 describe a method of making a core-shell ZSM catalyst, wherein the core-shell catalyst comprises a ZSM-5 core, and a silica shell disposed thereon, and its use for the cracking of light hydrocarbons to ethylene and propylene.

Verduijn et al in United States Patent Application 2002/0082460 disclose a catalyst comprising core crystals of a first zeolite and a discontinuous layer of smaller size second crystals of a second zeolite which cover at least a portion of the external surface of the first crystals for use in catalytic cracking, alkylation, disproportional of toluene, isomerization, and transalkylation reactions.

Calcium compounds have long been known to be effective traps for halogens in the preparation of chlorine-containing feeds such as mixed plastics. Badiola et al. in United States Patent Application 2023/0002681 describe a process for pyrolyzing plastics in the presence of catalysts to which a “co-injection material” such as CaO can be added to trap halogens. The added material and catalyst may be “bodies of one homogeneous composition”, or “distributed between two or more bodies.” No mention is made of core-shell type catalyst structures with thin shells on cores of catalyst.

In light of current commercial practices and the disclosures of art, a simple, economical, rapid means of protecting catalyst activity in a catalytic pyrolysis process utilizing polymeric hydrocarbonaceous feed materials containing impurities such as halogens, metals, or minerals is needed. The present invention provides such a process by employing a catalyst that limits the ability of the contaminants present in the feed to reach the catalytically active sites and improves the ability to remove contaminants from used catalysts. The combination of feed pretreatment, post-reaction catalyst washing, and core-shell catalysts provides an integrated system for managing and preserving catalyst activity.

### SUMMARY OF THE INVENTION

In a first aspect, this invention provides a process for catalytically pyrolyzing polymeric hydrocarbonaceous materials to valuable products, comprising: contacting a stream comprising at least 50% by weight plastics with a core-shell catalyst in a fluid bed catalytic reactor, wherein the core-shell catalyst comprises: a core comprising a zeolite and a shell having a thickness in the range of 0.01 to 100 microns which covers at least a portion of the surface of the core, and recovering paraffins, olefins, or aromatics or some combination thereof from the product stream. Preferably, the shell has a thickness in the range of 0.01 to 100 microns. Alternatively, throughout this application, the catalyst can be a mixture of cores in a matrix wherein the cores comprise a zeolite and the matrix comprises at least 5 mass % Ca. The cores may be pure zeolite or zeolite combined with a binder. Preferably at least 90 mass % of the cores have diameters in the range of 5 to 500 μm, or 25 to 250 μm, or 50 to 150 μm, or 15 to 100 μm. The matrix should be sufficiently porous to permit the diffusion of hydrocarbon molecules having a mass of 100 Daltons or less. The matrix is preferably one or more calcium compounds plus binder materials. The mass ratio of cores to matrix is preferably in the range of 0.5 to 20, or 1 to 10.

In another aspect, this invention provides a process for preserving catalyst activity of catalysts used for catalytic pyrolysis of hydrocarbonaceous materials by using a core-shell catalyst in a catalytic pyrolysis process that includes pretreating at least a portion of a stream comprising at least 50% by mass plastics to remove impurities, contacting at least a portion of the stream of pretreated polymeric hydrocarbonaceous materials with a core-shell zeolite catalyst in a fluid bed catalytic reactor to form a product stream comprising olefins, paraffins, and aromatics, wherein the core-shell zeolite catalyst comprises: a core comprising a zeolite, and a basic shell having a thickness in the range of 0.01 to 100 microns, which covers at least a portion of the surface of the core, recovering paraffins, olefins, or aromatics or some combination thereof from the products.

In a further aspect, this invention provides a process for producing valuable products by catalytically pyrolyzing polymeric hydrocarbonaceous materials, by contacting a stream of polymeric hydrocarbonaceous materials comprising plastics, with a core-shell zeolite catalyst in a fluid bed catalytic reactor to produce a product stream comprising paraffins, olefins, and aromatics, removing catalyst from the catalytic reactor, regenerating at least a portion of the removed catalyst by reaction with an oxygen-containing gas in a regenerator, returning at least a portion of the oxidatively regenerated catalyst to the catalytic reactor, separating vapor products exiting the catalytic reactor from solids in a solid-separating device, and recovering paraffins, olefins, or aromatics from the product stream.

In another aspect, this invention provides a process for preserving catalyst activity of catalysts used for catalytic pyrolysis of hydrocarbonaceous materials by using a core-shell catalyst in a catalytic pyrolysis process that includes contacting a stream comprising polymeric hydrocarbonaceous materials with a core-shell zeolite catalyst in a fluid bed catalytic reactor, wherein the polymeric hydrocarbonaceous materials comprise at least 50% by mass plastics, wherein the core-shell catalyst comprises: a core comprising a zeolite, and a basic shell having a thickness in the range of 0.01 to 100 microns, which covers at least a portion of the surface of the core, removing catalyst from the catalytic reactor and regenerating at least a portion of the removed catalyst by reaction with an oxygen-containing gas in a regenerator, washing at least a portion of the oxidatively regenerated catalyst with an acidic aqueous solution, returning at least a portion of the oxidatively regenerated catalyst and the washed catalyst to the catalytic reactor, separating vapor products exiting the fluid bed catalytic reactor from solids in a solid-separating device, and recovering paraffins, olefins, or aromatics or some combination thereof from the vapor products.

In yet another aspect, this invention provides a system for maintaining catalyst activity by using a core-shell catalyst in a fluid bed catalytic pyrolysis process that includes a pretreatment facility for removing impurities such as AAEMs from polymeric hydrocarbonaceous materials by washing the feed with a wash solution, wherein the polymeric hydrocarbonaceous materials comprise at least 50% by mass plastics, a fluid bed catalytic reactor comprising a core-shell catalyst, wherein the core-shell catalyst comprises: a core comprising a zeolite, and a basic shell having a thickness in the range of 0.01 to 100 microns, which covers at least a portion of the surface of the core, contacting the stream comprising washed polymeric hydrocarbonaceous materials with the catalyst in the fluid bed reactor, removing catalyst from the catalytic reactor and regenerating at least a portion of the removed catalyst by reaction with an oxygen-containing gas in a regenerator, washing at least a portion of the oxidatively regenerated catalyst with an acidic aqueous solution, discarding a portion of the oxidatively regenerated catalyst, returning at least a portion of the oxidatively regenerated catalyst and the washed catalyst to the catalytic reactor, adding to the reactor a portion of fresh catalyst equal to the discarded portion of catalyst, separating vapor products exiting the fluid bed catalytic reactor from solids in a solid-separating device, and recovering paraffins, olefins, or aromatics or some combination thereof from the vapor products.

In any of its aspects, the invention can include one or any combination of the following features:

### Catalyst

The catalyst comprises a catalytically active core material and a shell that limits direct exposure of the core material to the feedstock;
The catalytic core, the shell, or both comprise a zeolite;
The zeolite comprises a large pore zeolite with a pore size of at least about 7 A (1 A=0.1 nm) selected from among ETL, VFI, MAZ, MEI, FAU, EMT, OFF, BEA, and MOR structure type zeolites, mazzite, offretite, zeolite L, VPI-5, zeolite Y, zeolite X, omega, Beta, ZSM-3, ZSM-4, ZSM-18, ZSM-20, SAPO-37, and MCM-22, or combinations thereof;
The zeolite comprises an intermediate pore size zeolite (5-7 A pores) selected from among ZSM-5, ferrierite, zeolite Y, zeolite beta, mordenite, MCM-22, ZSM-11, ZSM-12, ZSM-22, ZSM-23, ZSM-34, ZSM-35, ZSM-38, ZSM-48, ZSM-50, ZSM-57, silicalite, silicalite 2, SUZ-4, EU-1, (S)A1P0-31, SSZ-23, MFJ, MEL, MTW, EUO, MTT, HEU, FER, MFS, and TON structure type zeolites, or combinations thereof;
The zeolite comprises a small pore zeolite (3-5 A pores) chosen from among CHA, ERI, KFI, LEY and EIA structure type zeolites, ZK-4, SAPO-34, SAPO-35, ZK-14, SAPO-42, ZK-21, ZK-22, ZK-5, ZK-20, zeolite A, erionite, chabazite, zeolite T, gmelinite, ALPO-17, and clinoptilolite, or combinations thereof;
The average pore size of the core material is smaller than the average pore size of the shell, or the average pore size of the core may be larger than the average pore size of the shell, or the pores of the core and shell may be of similar size;
The core-shell catalyst comprises a promoter chosen from among nickel, palladium, platinum, titanium, vanadium chromium, manganese, iron, cobalt, zinc, copper, gallium, phosphorus, the rare earth elements, i.e., elements 57-71, cerium, zirconium, or any of their oxides or some combination thereof;
The catalyst shell comprises one or more material selected from among silica, alpha-, beta-, or gamma-alumina, activated alumina, cerium oxide, titanium dioxide, zirconia, gallium oxide, zinc oxide, hafnium oxide, yttrium oxide, lanthanum oxide, or any combination thereof, or any of these oxides that have been doped with Ca or Mg;
The catalyst shell comprises one or more material selected from among clay minerals including layered montmorillonites, bentonites, hectorites, beidellites, vermiculites, nontronite, saponite, smectite and other Fullers earths, attapulgite (palygorskite), or sepiolite, talc (Mg₃Si₄O₁₀(OH)₂, or layered silicate minerals such as kaolin;
The catalyst shell comprises one or more material selected from among, or derived from, layered double hydroxides (LDHs) such as hydrotalcites, quintinite, hydrocalumite, or brucite, or similar structures, preferably those that contain Ca, Mg, or both Ca and Mg;
The catalyst shell comprises at least 1%, 2%, 5%, 10%, 20%, 30%, 50%, or 70%, or from 1% to 70%, 2% to 50%, or 5% to 30% by mass calcium, or magnesium, or the sum of calcium and magnesium;
The core-shell catalyst comprises a core and a shell which has a mass ratio of core:shell of 0.5:1, 2:1, 4:1, 7:1, 15:1, 25:1, 50:1, 100:1, or 1100:1, or between 0.5:1 to 1100:1, 1:1 to 100:1, 1:1 to 25:1, 0.5:1 to 15:1, 2:1 to 7:1, or 3:1 to 6:1;
The core-shell catalyst comprises a core and a shell in which the ratio of the shell thickness to the core diameter is 0.0001, 0.001, 0.01, 0.05, 0.1, 0.25, 0.5, 1, or 2, or between 0.0001 to 0.25, 0.001 to 0.025, 0.01 to 0.25, 0.05 to 0.5, 0.1 to 2, or 0.25 to 1;
The shell of the core-shell catalyst is applied to the core by impregnation, spray drying, deposition, dip-coating, spin-coating, casting, filtration, lay-by-layer assembly, or by fluidization of the core with particles of the shell material, or some combination of these;
The shell of the core-shell catalyst is applied to the core by fluidizing the core with small particles of shell material or precursor material in the catalytic pyrolysis reactor;
The shell of the core-shell catalyst is applied with a binder or filler or some combination of binder and filler in an amount of 10 to 90, 20 to 80, or 35 to 60, or at least 5, 10, 25, 35, 50, or 70% by mass of the total shell material;
The core-shell catalyst is etched to increase porosity of the shell after initial preparation; etching of a core-shell catalyst can be done before or after calcination of the core-shell composite;
Possible etching materials include hydrofluoric acid, ammonium fluoride, sodium hydroxide, nitric acid, hydrochloric acid, hydroiodic acid, hydrobromic acid, boric acid, boron trifluoride, sulfuric acid, acetic acid, formic acid, oxalic acid, or any combination thereof;
The catalyst is a fluid bed catalyst;
The core-shell catalyst is suitable for both batch and continuous processes; and/or
The core of the core-shell catalyst is an acidic material and the shell of the core-shell catalyst is a basic material.

### Catalytic Pyrolysis Process

The catalytic pyrolysis process may comprise the conversion of polymeric hydrocarbonaceous materials to hydrocarbon products, comprising feeding plastics, wastes into a reactor, pyrolyzing the plastics in the reactor in the presence of a core-shell catalyst that catalyzes the pyrolysis reaction and recovering aromatics, olefins, paraffins, or some combination from the products;
Polymeric hydrocarbonaceous materials suitable as feedstocks for the process comprise plastics chosen from among thermoplastic polymers such as, for example, polyethylene, polypropylene, polyesters, polyethylene terephthalate (PET), acrylonitrile-butadiene-styrene (ABS) copolymers, polyamide, polyurethane (PU), polyethers, polycarbonates (PC), poly(oxides), poly(sulfides), polyarylates, polyetherketones, polyetherimides, polysulfones, polyurethanes, polyvinyl alcohols, and polymers produced by polymerization of monomers, such as, for example, dienes, olefins, styrenes, acrylates, acrylonitrile, methacrylates (MMA), methacrylonitrile, diacids and diols, lactones, diacids and diamines, lactams, vinyl halides, vinyl esters, block copolymers thereof, and alloys thereof, thermoset polymers such as, for example, epoxy resins; phenolic resins; melamine resins; alkyd resins; vinyl ester resins; unsaturated polyester resins; crosslinked polyurethanes; polyisocyanurates; crosslinked elastomers, including but not limited to, polyisoprene, polybutadiene, styrene-butadiene, styrene-isoprene, ethylene-propylene-diene monomer polymer, and blends thereof, mixtures of polymers separated from municipal solid waste or other waste streams, or some combination thereof;
The residence time of gases or feed molecules in the catalytic pyrolysis reactor is at least 0.2, 0.5, 1, 2, 5, 10, or 30 seconds, or in the range of 0.2 to 480, 0.5 to 240, 1 to 30, 0.5 to 10, 10 to 120, or from 30 to 60 seconds;
The temperature in the catalytic pyrolysis reactor where catalyst is present is at least 400, 450, 500, 540, 550, or 575° C., or in the range of 400 to 700° C., 450 to 650° C., 500 to 650° C., 520 to 600° C., 500 to 575° C., 550 to 600° C., 575 to 625° C., or 540 to 580° C.;
The pressure in the catalytic pyrolysis reactor is at least 1.1, 2, 4, or 10 bara, or from 0.5 to 10, 0.9 to 4, or from 1 to 2 bara;
The catalytic pyrolysis is operated with a solid catalyst-to-hydrocarbonaceous feed mass ratio of at least 0.5:1, 1:1, 2:1, 5:1, 10:1, 15:1, 20:1, 30:1 or higher in some embodiments, or from 2:1 to 50:1, 3:1 to 20:1, or 4:1 to 10:1;
The catalytic pyrolysis process comprises a feed mechanism for passing feed into the reactor, a reactor fitted with a catalyst, an outlet for products to pass out of the reactor, a solids separator that separates solids from the product stream exiting the reactor and returns a portion or all the solids to the reactor, an optional steam stripper to remove materials from the used catalyst, a regenerator for oxidatively regenerating the catalyst, a conduit for transporting solids from the reactor to the regenerator, a conduit for transporting solids from the regenerator to the reactor, an exit port on the regenerator to permit the exhaust of flue gas, a product condenser to condense heavy products from the product stream, and a product collection and separation train to separate the products into valuable fractions such as BTX, olefins, paraffins, and non-condensable gases;
The catalytic pyrolysis is conducted in a circulating, or turbulent fluidized bed reactor; and/or
The catalytic pyrolysis may be conducted in a bubbling bed reactor.

### Regeneration

The catalyst removed from the reactor is oxidatively regenerated by contact with an oxygen-containing gas or other oxidant;
The oxidant for the oxidative regeneration comprises oxygen, air, oxygen-enriched air, steam, or CO₂ or some combination of these;
The step of oxidative regeneration may be conducted at a temperature of at least 550° C., 575° C., 600° C., 625° C., or 650° C., or from 500° C. to 700° C., 500° C. to 650° C., 500° C. to 600° C., 550° C. to 700° C., 550° C. to 650° C., 575° C. to 650° C., or 600° C. to 650° C., or less than 750° C., 700° C., 675° C., or 650° C.;
The catalyst that is contacted with the oxidant comprises at least about 0.1%, 0.2%, 0.5%, 1.0%, 1.5%, 2.0%, 2.5%, 3%, 4%, 5%, or 7% by weight carbon, or from 0.1 to 10%, 0.1 to 5%, 0.2 to 3%, or 0.5 to 2.5% by weight carbon based on the total weight of catalyst including any contaminants;
The oxidatively regenerated and washed catalyst has a lower percentage of carbon than the catalyst removed from the catalytic pyrolysis reactor;
At least a portion of the catalyst that has been treated with an oxidant is passed through one or more cyclones to separate the catalyst from ash;
The step of reacting with an oxidant is conducted prior to the step of washing;
The step of reacting with an oxidant is conducted after the step of washing;
At least a portion of hot flue gas from the oxidative regeneration process is used to heat the catalytic pyrolysis reactor;
Prior to the step of oxidatively regenerating the catalyst, the catalyst removed from the catalytic pyrolysis reactor is stripped of volatile materials by passing a stream comprising steam through the catalyst and collecting the products;
At least a portion of the oxygen-containing gas that exits from the combustion zone is recycled back into the combustion zone;
At least a portion of the hot flue gas from the combustion zone is used to heat the catalytic pyrolysis reactor;
The step of reacting used catalyst with an oxidant results in a hot regenerated catalyst that is returned to the pyrolysis reactor;
The carbon content of the oxidatively regenerated catalyst is less than 2.0%, 1.5%, 1.0%, 0.6%, 0.3% 0.2%, 0.1%, 5000 ppm, 1000 ppm, or less than 250 ppm; and/or
The carbon content of the oxidatively regenerated catalyst is greater than 1.0%, 0.6%, 0.3% 0.2%, 0.1%, 5000 ppm, 1000 ppm, or greater than 250 ppm, or in the range from 100 ppm to 2.0%, 0.1% to 1.5%, 0.1% ppm to 1.0%, or 0.2% to 1.0%;
   Catalyst washing
The wash solution used to wash the catalyst is selected from among water, acidic water, water with surfactants, water with multi-dentate ligands (such as EDTA, polyvinyl alcohol, oxalic acid), alcohols, ethers, organic acids, amines, ammonium salts including ammonium nitrate, ammonium acetate, ammonium citrate, ammonium phosphate, or supercritical CO₂, phosphoric acid, sulfuric acid, nitric acid, or some combination of these;
The wash solution is an aqueous solution;
The wash solution comprises at least 90%, 95%, or at least 99% water;
The pH of the wash solution is less than 5, 4, 3, 2, or 1, or from 0.01 to 5, 0.01 to 3, 0.1 to 2.5, or 0.1 to 2;
The wash solution comprises sulfuric acid and has a pH of less than 4, 3, 2, 1.5, or 1.1, or from 0.01 to 5, 0.01 to 3, 0.1 to 2.5, or 0.1 to 2;
The catalyst is introduced into the washing reactor as a solid or as a slurry;
The washing process is operated at a temperature of at least 15, 20, 35, 50, or 90° C., or from −20 to 200, from 20 to 100, or from 25 to 75° C.;
The temperature of the washing process is maintained at no more than 200° C., 150° C., 100° C., or 50° C., or in the range from 15 to 150° C., 15 to 100, 20 to 75, or 20 to 50° C.;
The chamber in which catalyst and wash solution are mixed is fitted with a cooling mechanism to prevent undesirable high temperatures;
The washing is conducted under pressure, with absolute pressures of at least 1.1, 2, 4, or 10 bara, or from 0.5 to 10, 0.9 to 4, or from 1 to 2 bara;
The process can include more than one washing step with the same wash solution or different wash solutions in each step;
The wash process is a batch process or a continuous process;
A continuous wash process is conducted with countercurrent flow of catalyst and wash solution in one vessel, or in multiple vessels wherein the catalyst and wash solutions move between vessels in a counter current fashion;
The average solids contact time in the vessel, defined as the bed height divided by the particles hindered settling velocity (the velocity at which a particle settles in the presence of other particles) is at least 20, 30, 40, 50, 60, 80 or from 40 to 60, 50 to 80, 80 to 100 minutes;
Where the liquid to solids mass ratio in the washing vessel is at least 2, 3, 4, 5, 10 or from 2 to 25, 2 to 10, 2 to 5, 5 to 8 or 8 to 10;
The used wash solution is treated to remove at least a portion of the materials washed from the catalyst and the wash solution is recycled to a washing step;
The rinse solution is water, deionized water, distilled water, or an aqueous solution with less than 25 ppm of K, 25 ppm of Na, 100 ppm of Ca and less than 100 ppm of Mg, or some combination thereof;
The washed catalyst contains a lesser amount of one or more of the following elements Ca, Na, K, or Mg, or combinations thereof after the washing step than were present prior to the washing step. wherein the percentage is based on the weight of liquid-free catalyst;
The K, or Na contents or their sum in the washed catalyst is less than 500 ppm, 400 ppm, 300 ppm, 200 ppm, 100 ppm, 50 ppm, or less than 25 ppm by mass when expressed as oxides;
The K, or Na contents or their sum in the catalyst prior to washing is in the range from 100 ppm to 600 ppm, 200 ppm to 600 ppm, or 200 ppm to 1000 ppm, by mass when expressed as oxides;
The washed catalyst has at least 30%, 40%, 50%, 60%, 70%, 80%, or 90%, or less than 150%, 140%, or 135%, or from 30% to 175%, 50% to 150%, 70% to 150%, or from 80% to 140% of the Brønsted acid site density (mmol/kg) as compared to a freshly prepared catalyst. Unless described otherwise, Brønsted acid sites are determined by deconvoluting the IPA-TPD trace as shown in the examples. The term “a freshly prepared catalyst” refers to the catalyst that has not been regenerated and is in the state that it is added to a catalytic pyrolysis reactor.
The Brønsted acid site density (mmol/kg) of the catalyst may increase at least 15%, 20%, 25%, 30%, or 40%, or from 1% to 75%, 10% to 70%, or 20% to 60% after washing compared to the Brønsted acid site density of the catalyst before washing;
The Brønsted acid site density (mmol/kg) of the catalyst after washing is at least 30, 40, 50, 60, 70, 75, 80, 85, 90, 95, 100, or 110, or from 30 to 150, 70 to 140, or from 80 to 120 mmol/kg as measured by an IPA-TGA adsorption experiment;
The portion of the oxidatively regenerated catalyst sent to the wash is only a portion, such as 0.1 to 10%, 1 to 50%, 2 to 40%, 5 to 35%, or 10 to 30%, or less than 50%, 25%, 10%, 5%, or less than 1%, of the oxidatively regenerated catalyst;
Catalyst that has been washed with wash solution is separated from the wash solution or rinse solution and at least a portion of the separated catalyst is added to the reactor for the catalytic pyrolysis of plastic;
The shell of the washed catalyst may be replenished by solution impregnation, spray drying, deposition, dip-coating, spin-coating, casting, filtration, lay-by-layer assembly, or preferably by fluidization of the washed catalyst with dust of the shell material, or some combination of these before being returned to the catalytic pyrolysis reactor; and/or
The washed catalyst is contacted with Ca, Mg, or both Ca and Mg containing materials that form a portion of the shell of the catalyst to replenish the shell before being returned to the catalytic pyrolysis reactor.

### Catalyst Activity Management System

A system for maintaining and preserving catalytic activity for catalytic pyrolysis of polymeric hydrocarbonaceous materials comprising at least 50% by mass plastics comprising feed pretreatment, catalytic pyrolysis, steam stripping of the catalyst, catalyst oxidative regeneration, and catalyst washing;
The system wherein the catalyst is a core-shell catalyst;
The system wherein the amount of fresh catalyst that replaces spent catalyst in a day is an amount such that the molar amount of Ca, Mg, or Ca and Mg in the shell of the fresh catalyst is at least equal to 0.5, 0.75, 1, 1.5, or 2, or from 0.5 to 5, 0.5 to 3, or 0.5 to 2 times the molar amount of halogens fed to the process in a day.

The catalyst is typically in the form of particles and the pyrolysis of feed materials is conducted in a fluidized bed reactor. Preferably, the core-shell catalyst comprises a zeolite in the core. In some preferred embodiments, the invention provides a catalyst for the catalytic pyrolysis process wherein the amount of impurity elements deposited in the zeolite core during the pyrolysis reaction is less when using the core-shell catalyst than the amount of impurity elements deposited in a zeolite catalyst without a shell under similar conditions.

Impurity elements that deposit on the core-shell catalyst can be removed by a washing process. In some preferred embodiments impurity elements deposited on the core-shell catalyst have been at least partially, but not completely removed. In these cases, the deposited elements may comprise greater than 1.0%, 0.6%, 0.3% 0.2%, 0.1%, 5000 ppm, 1000 ppm, 600 ppm, or greater than 250 ppm, or in the range from 100 ppm to 2.0%, 0.1% to 1.5%, 0.1% to 1.0%, or 0.2% to 2.0% of the total mass of catalyst plus contaminants. The invention includes intermediates such as the catalyst that has been washed with a wash solution.

In some embodiments, the depleted shell is periodically removed by abrasion and a fresh shell is added to the catalyst core by fluidized bed coating, electrostatic spray deposition, or any other commonly used method, followed by calcination.

This invention further provides a method for regenerating a coke contaminated catalytic pyrolysis catalyst by contacting the catalyst with an oxidizing gas in a fluidized bed or other regenerator, separating the regenerated catalyst from the flue gas, washing a portion of the separated catalyst, and returning at least a portion of the regenerated and washed catalyst to the catalyst feed hopper of the catalytic pyrolysis reactor. In the method for regenerating a coke and minerals contaminated catalytic pyrolysis catalyst, the process includes the steps of: (1) introducing oxidizing regeneration gas and coke-contaminated catalyst into a combustion zone maintained at a temperature sufficient for coke oxidation and therein oxidizing coke to produce hot regenerated catalyst and hot flue gas; (2) transporting at least a portion of the hot flue gas and at least a portion of the hot regenerated catalyst from the combustion zone into a regenerated catalyst disengaging zone, wherein the hot oxidatively regenerated catalyst is separated from the flue gas; (3) optionally transporting at least a portion of the separated catalyst from the disengaging zone to a catalyst washing zone and contacting the catalyst with a wash solution, and (4) separating the washed catalyst from the wash solution and returning it, and the remainder of the oxidatively regenerated catalyst, to the fluid bed catalytic pyrolysis reactor.

The process may include the steps of (1) treating a partially deactivated catalyst with a steaming/stripping gas, (2) introducing oxidizing regeneration gas and the steamed/stripped coke-contaminated catalyst into a combustion zone maintained at a temperature sufficient for coke oxidation and therein oxidizing coke to produce hot regenerated catalyst and hot flue gas; (3) transporting at least a portion of the hot flue gas and at least a portion of the hot regenerated catalyst from the combustion zone into a regenerated catalyst disengaging zone, wherein the hot regenerated catalyst is separated from the flue gas; (4) optionally transporting a portion of the separated catalyst from the disengaging zone to a catalyst washing zone and contacting the catalyst with a wash solution, and (5) separating the washed catalyst from the wash solution and returning it, and the remainder of the oxidatively regenerated catalyst, to the fluid bed catalytic pyrolysis reactor.

The invention includes systems or methods comprising the apparatus which maintains the time-averaged maximum or transient maximum temperature in the catalyst regenerator at a temperature of at least 550° C., 575° C., 600° C., 625° C., or 650° C., or from 500° C. to 700° C., 500° C. to 650° C., 550° C. to 700° C., 550° C. to 650° C., 575° C. to 650° C., or 600° C. to 650° C., or less than 750° C., 700° C. or 675° C. Preferably, the catalyst regenerator comprises a fluidized bed reactor adapted so that the regeneration gas inlet provides at least a portion of the fluidization gas.

In any of the inventive aspects, optionally, gas from the combustion chamber(s) can be used elsewhere in a process, preferably by heating the catalytic pyrolysis reactor or recycled into the combustion chamber or used in the thermal pretreatment of the feed. The catalyst regeneration process may comprise more than one combustion chamber in series or in a single combustion chamber but at two different temperatures.

The invention also includes apparatus and systems (which include apparatus, chemical compositions and/or conditions within apparatus).

### Glossary

Aromatics— As used herein, the terms “aromatics” or “aromatic compound” are used to refer to a hydrocarbon compound or compounds comprising one or more aromatic groups such as, for example, single aromatic ring systems (e.g., benzyl, phenyl, etc.) and fused polycyclic aromatic ring systems (e.g. naphthyl, 1,2,3,4-tetrahydronaphthyl, etc.). Examples of aromatic compounds include, but are not limited to, benzene, toluene, indane, indene, 2-ethyl toluene, 3-ethyl toluene, 4-ethyl toluene, trimethyl benzene (e.g., 1,3,5-trimethyl benzene, 1,2,4-trimethyl benzene, 1,2,3-trimethyl benzene, etc.), ethylbenzene, styrene, cumene, methylbenzene, propylbenzene, xylenes (e.g., p-xylene, m-xylene, o-xylene, etc.), naphthalene, methyl-naphthalene (e.g., 1-methyl naphthalene, anthracene, 9.10-dimethylanthracene, pyrene, phenanthrene, dimethyl-naphthalene (e.g., 1,5-dimethylnaphthalene, 1,6-dimethylnaphthalene, 2,5-dimethylnaphthalene, etc.), ethyl-naphthalene, hydrindene, methyl-hydrindene, and dymethyl-hydrindene. Single-ring and/or higher-ring aromatics may also be produced in some embodiments.

AAEMs—As used herein, the term “alkali and alkaline earth metals” (AAEMs) comprise the metals in Groups 1 and 2 of the Periodic Table as agreed by the International Union of Pure and Applied Chemistry (IUPAC) including Li, Na, K, Rb, Cs, Fr, Be, Mg, Ca, Sr, Ba and Ra. The term AAEMs may also comprise additional elements that are frequently found in waste plastics or biomass along with the Group 1 and 2 elements, including Si, P, Al, Fe, Cu, Zn, Mn, or other metals in small concentrations, or combinations of these. The term AAEMs is meant to convey the sum of the elements other than C, H, O, N, and S that are found in hydrocarbonaceous materials and are not susceptible to conversion to hydrocarbonaceous fluid products. These elements are often found as salts, oxides, or in combination with various organic molecules, and are sometimes referred to as minerals.

Without wishing to be bound by theory, there are several mechanisms by which impurities such as AAEMs, or other metals, are believed to poison or deactivate pyrolysis catalysts. AAEMs can react with Al/Si materials such as zeolites to form KAlSiO4 (kaliophilite), or similar materials that are refractory, thus destroying the zeolite structure and causing irreversible loss of catalyst activity. Most damaging, AAEMs ions can ion exchange with protons at the Brønsted acid sites of a zeolite to neutralize its acidity.

BarA (bara)—Absolute Pressure; Pressure reading relative to absolute vacuum.

BTX—Benzene, toluene, and xylenes

Catalysts—Catalyst components useful in the context of this invention can be selected from any catalyst known in the art, or as would be understood by those skilled in the art. Catalysts promote and/or affect reactions. Thus, as used herein, catalysts lower the activation energy (increase the rate) of a chemical process, and/or improve the distribution of products or intermediates in a chemical reaction (for example, a shape-selective catalyst). Examples of reactions that can be catalyzed include dehydration, dehydrogenation, isomerization, hydrogen transfer, aromatization, decarbonylation, decarboxylation, aldol condensation, and combinations thereof. Catalyst components can be considered acidic, neutral or basic, as would be understood by those skilled in the art.

Coke—Coke is the carbonaceous material that is deposited on a catalyst during the pyrolysis reaction by the decomposition of hydrocarbonaceous materials. The carbon content of coke is typically at least 80%, and it contains smaller amounts of hydrogen and other heteroatoms (O, Cl, S, N, Br, etc.). The word ‘carbon’ is sometimes used to indicate coke-like carbon deposits.

Contact—“Contacting”, as used herein, means that two surfaces are within 10 nm of one another.

Conversion—The term “conversion of a reactant” refers to the reactant mole or mass change between a material flowing into a reactor and a material flowing out of the reactor divided by the moles or mass of reactant in the material flowing into the reactor. For example, if 100 grams of ethylene are fed to a reactor and 30 grams of ethylene are flowing out of the reactor, the conversion is [(100−30)/100]=70% conversion of ethylene.

Core-shell—The terms “core/shell” or “core-shell” or “yolk-shell” refer to structures having an inner “core” that comprises a catalytic material and an outer shell that encompasses or encapsulates the core, preferably where the core contacts at least 50% to 100%, preferably 60 to 90%, of the inside surface of the shell. A non-limiting illustration of a core/shell structure is one where the core contacts at least 90% or more of the inside surface of the shell or completely fills a void space that is defined by the inner surface of the shell. Determination of whether a given structure is a core-shell structure can be made by persons of ordinary skill in the art. One example is visual inspection of a transition electron microscope (TEM) or a scanning transmission electron microscope (STEM) image of a structure and determining whether the inner core or yolk contacts at least 50% of the inner surface of the shell. In some embodiments, the majority (by mass) of the particles contain a single core encapsulated by a shell, e.g. as shown in FIG. 1A. In other embodiments, the particles comprise multiple cores encapsulated by a single shell material, e.g. as shown in FIG. 1B.

Diameter— Diameter is the largest dimension of a particle.

Fluidized Bed Reactor—The term “fluidized bed reactor” is given its conventional meaning in the art and is used to refer to reactors comprising a vessel that can contain a granular solid material (e.g., silica particles, catalyst particles, etc.), in which a fluid (e.g., a gas or a liquid) is passed through the granular solid material at velocities sufficiently high as to suspend the solid material and cause it to behave as though it were a fluid. Examples of fluidized bed reactors are described in “Fluidization Engineering” by D. Kunii and O. Levenspiel, Butterworth-Heinemann, 1991, incorporated herein by reference.

Bubbling fluidized bed reactors and turbulent fluidized bed reactors are known to those skilled in the art. In bubbling fluidized bed reactors, the fluid stream used to fluidize the granular solid material is operated at a sufficiently low flow rate such that bubbles and voids are observed within the volume of the fluidized bed during operation. In turbulent fluidized bed reactors, the flow rate of the fluidizing stream is higher than that employed in a bubbling fluidized bed reactor, and hence, bubbles and voids are not observed within the volume of the fluidized bed during operation. Examples of circulating, bubbling, and turbulent fluidized bed reactors are described in Kirk-Othmer Encyclopedia of Chemical Technology (online), Vol. 11, Hoboken, N.J.: Wiley-Interscience, 2001, pages 791-825, incorporated herein by reference.

Olefins—Olefins, also known as alkenes, are hydrocarbons containing a carbon-carbon double bond. The double bond may be internal or in the terminal position.

Paraffins—The term “paraffin” is a name for an alkane in general, but preferably refers to a linear, or normal alkane.

Plastics—The terms “plastics” as used herein represents many carbon-based polymers (at least 50 mass % C) material chiefly made up of repeating units and having a number average molecular weight of at least 100, typically greater than 1000 or greater than 10,000. Plastics include thermoplastic polymers such as, for example, polyethylene, polypropylene, polyesters, polyethylene terephthalate (PET), acrylonitrile-butadiene-styrene (ABS) copolymers, polyamide, polyurethane (PU), polyethers, polycarbonates (PC), poly(oxides), poly(sulfides), polyarylates, polyetherketones, polyetherimides, polysulfones, polyurethanes, polyvinyl alcohols, and polymers produced by polymerization of monomers, such as, for example, dienes, olefins, styrenes, acrylates, acrylonitrile, methacrylates (MMA), methacrylonitrile, diacids and diols, lactones, diacids and diamines, lactams, vinyl halides, vinyl esters, block copolymers thereof, and alloys thereof, thermoset polymers such as, for example, epoxy resins; phenolic resins; melamine resins; alkyd resins; vinyl ester resins; unsaturated polyester resins; crosslinked polyurethanes; polyisocyanurates; crosslinked elastomers, including but not limited to, polyisoprene, polybutadiene, styrene-butadiene, styrene-isoprene, ethylene-propylene-diene monomer polymer; and blends thereof. Mixtures of polymers separated from municipal solid waste or other waste streams are suitable feeds provided they contain only small fractions of contaminants such as S, N, O, or halogens. Polymers yielding halogenated material upon pyrolysis, for example, polyvinyl chloride (PVC), polytetrafluoroethylene (PTFE), and other halogenated polymers, are generally minimized or excluded from the feed materials useful in this invention.

Polymers—As used herein polymers includes manmade polymers such as plastics.

Pretreatment—The term “pretreatment” as used herein comprises any of the processes that are conducted to prepare the waste feed material for use in a catalytic pyrolysis or other upgrading process. Some of the processes that can be part of a pretreatment process include: 1) separating or grading by type of material, which selectively removes some materials that are not desirable and serves to make the feed mixture more homogeneous, 2) washing, which can include solvent or water or aqueous solution treatment to remove dirt, organic material clinging to the feed material, labels, or the like, 3) drying, which is the removal of water or other solvents or volatile materials, 4) sizing, which means cutting or comminuting or reducing the dimensions of larger particles into sizes more amenable to further processing, 5) contaminant removal, which can be a thermal or chemical or both thermal and chemical treatment that results in a reduction of the concentration of elements other than carbon and hydrogen, particularly removal of halides F, Cl, Br, or I, nitrogen, oxygen, sulfur, or metals, or a combination of these elements. Pretreatment processes may comprise any process selected from among collecting, separating, mixing, contaminant removal, dechlorination, dehalogenation, desulfurization, distilling, oxidizing, hydrotreating, pyrolyzing, washing, sizing, melting, pelleting, filtering, drying, or combinations thereof.

Pyrolysis—The terms “pyrolysis” and “pyrolyzing” are given their conventional meaning in the art and are used to refer to the transformation of a compound, e.g., a solid hydrocarbonaceous material, into one or more other substances, e.g., volatile organic compounds, gases, and coke, by heat, preferably without the addition of, or in the absence of, O2. Preferably, the volume fraction of O2 present in a pyrolysis reaction chamber is 0.5% or less. Pyrolysis may take place with or without the use of a catalyst. “Catalytic pyrolysis” refers to pyrolysis performed in the presence of a catalyst and may involve steps as described in more detail below. Examples of catalytic pyrolysis processes are outlined, for example, in Huber, G. W. et al, “Synthesis of Transportation Fuels from Biomass: Chemistry, Catalysts, and Engineering,” Chem. Rev. 106, (2006), pp. 4044-4098.

Residence Time—The residence time is defined as the volume of the reactor divided by the volumetric flow rate of fluidization fluid under process conditions of temperature and pressure.

Selectivity—The term “selectivity” refers to the amount of production of a particular product in comparison to a selection of products including permanent gases, C2-C4 light olefins, C1-C4 light paraffins, and C5+ hydrocarbons including benzene, toluene, and xylenes (BTX), aromatic and non-aromatic naphtha range molecules, C11+ hydrocarbons, coke and char, and minor byproducts. Selectivity to a product may be calculated by dividing the amount of the particular product by the amount of all or a selection of products produced. For example, if 75 grams of aromatics are produced in a reaction and 20 grams of benzene are found in these aromatics, the selectivity to benzene amongst aromatic products is 20/75=26.7%. Selectivity can be calculated on a mass basis, as in the aforementioned example, or it can be calculated on a carbon basis, where the selectivity is calculated by dividing the amount of carbon that is found in a particular product by the amount of carbon that is found in a selection of products. Unless specified otherwise, for reactions involving plastics as a reactant, selectivity is on a mass basis. For reactions involving conversion of a specific molecular reactant (ethene, for example), selectivity is the percentage (on a mass basis unless specified otherwise) of a selected product divided by all the products produced.

Steam Stripping—The term “steam-stripping”, also known as steam distillation, refers to a process commonly used for removing volatile contaminants from wastewater. Typically, wastewater feed streams enter a distillation column at the top and flow downward, while steam enters the column at the bottom and rises. Pressure/temperature phase differences between the steam and contaminants allow the steam to strip the contaminants from the water.

Thickness—Thickness refers to volume average thickness. The term “shell thickness” does not apply to a catalyst particle that comprises a plurality of core particles in a matrix. Thickness can be determined as calculated in the Examples. Alternatively, thickness can be measured via microscopy to show structures such as illustrated in FIG. 1. Cross-sections may be studied with scanning electron microscopy (SEM) or transmission electron microscopy (TEM). Preparation and analysis of cross-sections of particles can be accomplished as outlined in “Preparation of Cross Sections of Difficult Materials for SEM Imaging”, Payne, Scott A. and Moore, Jayma A., Microscopy Today, Volume 26, Iss. 3, May 2018, pp. 40-45. If the technique is not specified, thickness is measured by microscopy.

Yield—The term “yield” is used herein to refer to the amount of a product flowing out of a reactor divided by the amount of reactant flowing into the reactor, usually expressed as a percentage or fraction. Yields are often calculated on a mass basis, carbon basis, or on the basis of the mass of a particular feed component. Mass yield is the mass of a particular product divided by the weight of feed used to prepare that product. For example, if 500 grams of feed is fed to a reactor and 45 grams of benzene is produced, the mass yield of benzene would be 45/500=9% benzene. Carbon yield is the mass of carbon found in a particular product divided by the mass of carbon in the feed to the reactor. For example, if 500 grams of feed that contains 80% carbon is reacted to produce 350 grams of benzene that contain 92.3% carbon, the carbon yield is [(50*0.923)/(500*0.80)]=11.5%. Carbon yield from feed is the mass of carbon found in a particular product divided by the mass of carbon fed to the reactor in a particular feed component. Yields may be measured in batch experiments where a sample of polymeric hydrocarbonaceous material is added to a sample of catalyst at a temperature greater than 500° C. and the products are measured, as in the drop tube experiments described herein.

As is standard patent terminology, the term “comprising” means “including” and does not exclude additional components. Any of the inventive aspects described in conjunction with the term “comprising” also include narrower embodiments in which the term “comprising” is replaced by the narrower terms “consisting essentially of” or “consisting of.” As used in this specification, the terms “includes” or “including” should not be read as limiting the invention but, rather, listing exemplary components. As is standard terminology, “systems” include the apparatus and materials (such as reactants and products) and conditions within the apparatus.

### BRIEF DESCRIPTION OF THE FIGURES

FIG. 1 shows several conceptual arrangements of cores and shells in core-shell catalysts.

FIG. 2 presents a schematic of one embodiment of a catalytic pyrolysis process for producing valuable products from polymeric hydrocarbonaceous materials using core-shell pyrolysis catalysts.

FIG. 3 presents one embodiment of a pretreatment process for pretreating waste materials to make them suitable for catalytic upgrading.

FIG. 4 depicts an embodiment of a process for pretreating and catalytically pyrolyzing solid feed mixtures using a core-shell catalyst.

FIG. 5 shows a schematic of one embodiment of a catalyst activity management system for producing valuable products from polymeric hydrocarbonaceous materials using core-shell catalysts.

FIG. 6 shows the results of a model of steady state contaminant concentration on a catalyst as a function of resistance to poisoning for a 1% makeup rate of catalyst.

FIG. 7 shows the results of a model of steady state contaminant concentration on a catalyst as a function of resistance to poisoning for a 2% makeup rate of catalyst.

FIG. 8 presents the calculated maximum amount of Cl permissible in the feed to maintain catalyst activity as a function of the shell thickness for Ca-containing shell materials.

FIG. 9 presents the calculated maximum amount of Cl permissible in the feed to maintain catalyst activity as a function of the shell thickness for Mg-containing shell materials.

FIG. 10 shows the results of a model used to calculate shell thickness required for different particle size materials with shells derived from 50% CaCO₃ and a process operated with a 1% per day makeup rate.

### DETAILED DESCRIPTION

The halogens, minerals, or metallic elements present as contaminants in waste plastics or biomass present a challenge to catalytic processes. These elements can deactivate the catalyst or interfere with the smooth operation of a catalytic pyrolysis process by several different mechanisms. It is thus desirable to limit the impact of the contaminants during the catalytic process, or remove the contaminants, or both, in order to provide a commercially viable process for upgrading hydrocarbonaceous materials to fuels and chemicals. Other impurity elements, primarily halogens present in plastics, may also corrode the catalyst or the reactor or both. Any of these impurities can inhibit catalyst activity, complicate product purification, and contaminate effluent streams. The present invention addresses methods to reduce the impact of impurities in hydrocarbonaceous feeds on a catalytic pyrolysis process.

Compared to conventional zeolite catalysts, core-shell catalysts have a much higher capacity to trap impurities such as F, Cl, Br, I, Ca, K, Na, Mg, Fe or other metals, in the shell, reducing the need for catalyst replacement due to poisoning. Impurities trapped in the shell are more easily removed by extraction without damaging the zeolite structure or composition in the core. The shell portion of the core-shell catalyst can act as a filter to prohibit the diffusion of large molecules into the zeolite pores where they can form coke and block diffusion of small, reactive molecules within the zeolite channels. Calcium or magnesium contained within a catalyst shell can form soluble salts with halogens within the pores of the shell, preventing corrosion of the catalyst or reactor, and permitting facile removal with wash solutions. Where the shell has some acidic nature the acid functionality can catalyze the cracking of the larger molecules to smaller fragments that can diffuse into the zeolite pores. The acidic pores of the shell can also inhibit the diffusion of the vapor phases of catalyst poison metals, e.g. KOH, NaOH, etc. Acid sites also inhibit the migration of basic cations along the surfaces of the shell, trapping them at the acid sites. Where the shell of the core-shell catalyst has hydrophobic character, it can inhibit the diffusion of polar molecules into the core and reduce the deleterious effects of steam on the zeolite structure. The protective coating of the shell also serves to inhibit the migration of promoter metals out of the core zeolite, allowing metals such as Ga and Zn that have significant vapor pressures under reaction conditions to be more effectively retained in the zeolite structure where they enhance the selectivity and activity of the catalyst. The range of compositions, structures, and geometries available for the-shell of core-shell catalysts make them unusually adjustable to the needs of particular processes and feed conditions.

Core-shell or yolk shell catalysts are those catalysts that contain one material or structure that forms the central core of the catalyst and a different material that forms a shell surrounding the core. In some preferred embodiments of catalytic pyrolysis, the core or shell of the core-shell catalyst may be selected from naturally occurring zeolites, synthetic zeolites, and combinations thereof. A large pore zeolite generally has a pore size of at least about 7 Å (1 Å=0.1 nm) and includes ETL, VFI, MAZ, MEI, FAU, EMT, OFF, BEA, and MOR structure type zeolites. Examples of large pore zeolites, include mazzite, offretite, zeolite L, VPI-5, zeolite Y, zeolite X, omega, Beta, ZSM-3, ZSM-4, ZSM-18, ZSM-20, SAPO-37, and MCM-22. An intermediate pore size zeolite generally has a pore size from about 5 Å to about 7 Å and includes, for example, ZSM-48 type and MFI, MEL, MTW, EUO, MTT, HEU, FER, MFS, TON structure type zeolites. Examples of intermediate pore size zeolites include ZSM-5, ZSM-12, ZSM-22, ZSM-23, ZSM-34, ZSM-35, ZSM-38, ZSM-48, ZSM-50, ZSM-57, silicalite, and silicalite-2. A small pore size zeolite has a pore size from about 3 A to about 5 A and includes, for example, CHA, ERI, KFI, LEY and EIA structure type zeolites. Examples of small pore zeolites include ZK-4, SAPO-34, SAPO-35, ZK-14, SAPO-42, ZK-21, ZK-22, ZK-5, ZK-20, zeolite A, erionite, chabazite, zeolite T, gmelinite, ALPO-17, and clinoptilolite. These zeolites and their isotypes are described in “Atlas of Zeolite Framework Types”, eds. C. Baerlocher, L. B. McCusker and D. H. Olson, Elsevier, Sixth Edition, 2007, which is hereby incorporated by reference. All of these are described in IUPAC Commission of Zeolite Nomenclature. In other embodiments, non-zeolite catalysts may be used; for example, WOₓ/ZrO₂, aluminum phosphates, etc. In certain embodiments, the catalyst may be a ZSM-5 zeolite catalyst, as would be understood by those skilled in the art.

The catalyst core or shell or both may comprise a metal and/or a metal oxide. Suitable metals and/or oxides include, for example, nickel, palladium, platinum, titanium, vanadium chromium, manganese, iron, cobalt, zinc, copper, gallium, and/or any of their oxides, among others. In some cases, one or more promoter elements chosen from among phosphorus, the rare earth elements, i.e., elements 57-71, cerium, zirconium or their oxides or combinations of these may be included to modify activity or structure of the catalyst. In addition, in some cases, properties of the catalysts (e.g., pore structure, type and/or number of acid sites, etc.) may be chosen to selectively produce a desired product. Any of these materials may be used as a component of the core or the shell in the core-shell catalyst. In some cases, the average pore size of the core will be no larger than the average pore size of the shell or coating that is on the surface of the core. In other cases, the average pore size of the core will be larger than the average pore size of the shell.

Catalysts may be characterized by a concentration of Brønsted acid sites. Unless described otherwise, Brønsted acid sites are determined by deconvoluting the IPA-TPD trace. The surface area of a catalyst may be calculated by BET analysis and with the multipoint BET equation. Pore volume may be calculated from the maximum adsorption amount of nitrogen. The pore size distribution may be determined based on the Barrett-Joyner-Halenda (BJH) method and the desorption branch of the isotherm. The average pore sizes may be calculated by the equation Ps=4V/S, where Ps=pore size, V=pore volume, and S=surface area.

The zeolites may be used as the core of the catalytic pyrolysis catalyst without any binder or matrix, in a self-bound form. Alternatively, the zeolites may be composited with another material that is resistant to the temperatures and other conditions employed in the pyrolysis reaction. Such binder or matrix materials include active and inactive materials and synthetic or naturally occurring zeolites as well as inorganic materials such as clays and/or oxides such as alumina, silica, silica-alumina, zirconia, titania, magnesia, or mixtures of these and other oxides. The latter may be either naturally occurring or in the form of gelatinous precipitates or gels comprising mixtures of silica and metal oxides. Clays may also be included with the oxide binders to modify the mechanical properties of the catalyst or to assist in its manufacture. The relative proportions of zeolite and binder matrix vary widely, with the zeolite content ranging from 1 wt % to 90 wt %. In some embodiments, the composite is prepared in the form of fluidizable particles.

The shell of a core-shell catalyst may comprise other materials that provide specific functionality such as diffusion inhibition or promotion, sites for trapping impurities, catalytic activity for cracking large molecules, or dehydrating, decarbonylating, or decarboxylating oxygenated molecules, or hydrogenation, dehydrogenation, or cyclization. The shell may act as a buffer to trap and neutralize alkali metals. The shell thickness can be adjusted based on the expected levels of alkali metal poisoning.

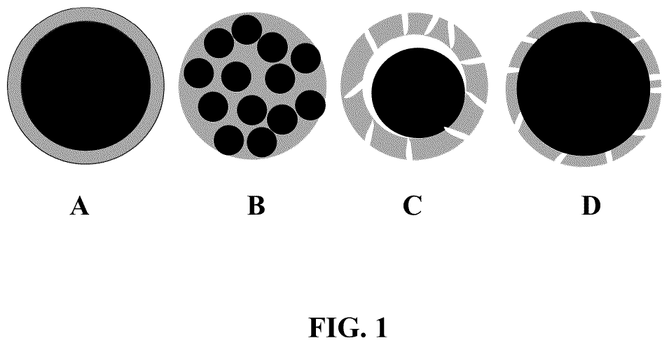

Several conceptual arrangements of core-shell catalysts are presented in FIG. 1 where the darker portion is the core and the lighter portion is the shell. Structure (A) show a single mass of core material encased in a thin layer of shell material. Structure (B) shows multiple masses of core material encased in a matrix of shell material. Structure (C) shows core material encased in shell material that has large pores in which the core and shell are not in direct contact at all surfaces of the core and there is some space between the core material and the shell. Structure (D) shows a mass of core material encased in shell material that has been etched to provide macropores to enhance access of feed materials to the core. These, or any variation of these arrangements, are contemplated as arrangements suitable for core-shell catalysts effective for catalytic pyrolysis.

The preferred structure type of the shell of the core-shell catalyst will depend on the structure type of the core and the particular hydrocarbonaceous feed material for which the coated zeolite catalyst is utilized. If the feed comprises a large fraction of paraffins, such as when waste plastics are catalytically pyrolyzed, the preferred pore size and structure type of the shell material will depend on the size of the molecules to be cracked and the desired product; small pore sizes for the shell may be preferred to inhibit penetration of the large molecules into the core.

In some embodiments, the shell material is catalytically active. In other embodiments, the shell is inactive, i.e., non-catalytic. The shell material can be an inorganic oxide or a mixed metal oxide. In some preferred aspects, where the feed material to the catalytic pyrolysis process includes halogenated materials, the shell material comprises Ca or Mg, or has a capacity for binding Ca or Mg. The shell can be formed from materials from the broad class of layered double hydroxides (LDHs) called hydrotalcites after the mineral hydrotalcite Mg₆Al₂CO₃(OH)₁₆·4H₂O. Heating hydrotalcites typically proceeds by the successive loss of adsorbed water, interlayer, carbon dioxide, and dihydroxylation, and is accompanied by micropores formation that is of great importance in producing oxide and oxide-supported catalysts. Cations that can be substituted for Mg include Ca, Mn, Fe, Ni, Cu, and Zn, while cations that can replace Al include Mn, Fe, Co, and Ni. The shell can be doped with additional elements, such as cerium, zirconium, copper, cobalt, iron, nickel, antimony, niobium, molybdenum, or hafnium, or some combination of these, to enhance its resistance to alkali metal poisoning. These dopants protect active centers, increase redox properties, and boost surface acidity. The catalyst shell can be doped with non-metal elements, such as sulfur (S) and phosphorus (P), to modify its alkali-poisoning resistance. The presence of SO₄⁻² or POs₃⁻ groups, when combined with alkali metals, increases surface acidity, making the catalyst more resilient to alkali metals. The wide variety of combinations make these materials highly tunable precursors to protective shells for core-shell catalysts.

In other preferred aspects, the shell has a hydrophobic and acidic character, such as a silica and TiOₓ shell, a composite silica-titania shell with the titania distributed in the silica, a porous silica layer having titania in the pores, or a titania layer between the core and silica outer shell. The shell can comprise metal oxides such as silica, alpha, beta, or gamma alumina, activated Al₂O₃, cerium oxide, titanium dioxide, zirconia, gallium oxide, zinc oxide, hafnium oxide, yttrium oxide, lanthanum oxide, or any combination thereof. The shell can have a porosity of 20% to 90% or from 40% to 70%. The shell can also have a mesoporous or macroporous structure.

In other preferred aspects, the shell has a basic character, such as selected from among materials containing one or more of Ca, Mg, Sr, Ba, Li, Na, K, Rb, or Cs, or amphoteric oxides of metals such as Zn, Pb, Al, Sn, V, Tl, Ce, or Zr, or combinations thereof. In some embodiments the sum of the masses of elements Ca, Mg, Sr, Ba, Li, Na, K, Rb, and Cs together constitute at least 5, 10, 25, 50, or 75, or from 1 to 75, 5 to 50, or 10 to 25% by mass of the shell. To provide halogen capturing capacity, materials, including zeolites and other acidic materials discussed above, can be doped or ion-exchanged with alkali or alkaline earth metals, preferably calcium or magnesium ions. The shell thickness and composition can be adjusted to control the degree of contact between the core material and the feedstock, offering fine-tuned control over reaction kinetics. The core of the core-shell catalyst may comprise an acidic material while the shell of the core-shell catalyst comprises a basic or amphoteric material, wherein a basic material is one that can absorb protons and the acidic materials is one that can donate protons or absorb alkali or alkaline earth metals.

In some embodiments the shell may be derived at least in part from Ca(OH)₂, CaCO₃, CaSO₄, CaO, Mg(OH)₂, MgCO₃, MgSO₄, or MgO, or some combination thereof. In some embodiments the shell may comprise at least 20%, 30%, 40%, or 50%, or from 10% to 95%, 20% to 90%, 30% to 75%, or 40% to 60% by mass Ca(OH)₂, CaCO₃, CaSO₄, CaO, Mg(OH)₂, MgCO₃, MgSO₄, or MgO, or materials derived from these, or some combination thereof. The shell can comprise clay minerals including layered montmorillonites, bentonites, hectorites, beidellites, vermiculites, nontronite, saponite, smectite and other Fullers earths, attapulgite (palygorskite), and sepiolite. Kaolin, a layered silicate mineral with one tetrahedral sheet of silica linked through oxygen atoms to one octahedral sheet of alumina octahedra, may be part of the shell. To improve the effectiveness of the clay in the shell, it may be leached with an acid solution to form a leached clay preparation, by treatment with an etching agent selected from the group consisting of nitric acid, hydrochloric acid, sulfuric acid, hydrofluoric acid, ammonium fluoride, the acid salt of ammonium fluoride, sodium hydroxide, boron trifluoride, acetic acid, oxalic acid, and formic acid, either before or after forming the core-shell catalyst. In some instances, the porous composite or the porous SiO₂ layer can have average aperture size (e.g., pore diameter) of less than 10 nm (100 Å), preferably less than 5 nm (50 Å), more preferably less than 2 nm (20 Å).

When the shell is an aluminosilicate zeolite, the silica to alumina mole ratio of the shell, will usually depend upon the structure type of the core zeolite and particular hydrocarbon process in which the catalyst is utilized and is therefore not limited to any particular ratio. The silica to alumina ratio will typically be at least 2:1. In some embodiments the shell preferably has a silica to alumina mole ratio greater than the silica to alumina mole ratio of the core, and more preferably greater than 200:1, 300:1, 500:1, or 1,000:1. In certain applications, the shell can comprise a Silicalite, i.e., the shell is a MFI structure type substantially free of alumina, or Silicalite-2, i.e., the shell is a MEL structure type substantially free of alumina. In other embodiments the shell preferably has a silica to alumina mole ratio less than the silica to alumina mole ratio of the core, and more preferably less than 200:1, 100:1, 50:1, 30:1, or 2:1.

The pore size of the shell may be a pore size that does not adversely restrict access of the desired molecules of the hydrocarbon feed to the catalytic phase of the core. For instance, when the materials of the feed to be converted by the core have a size from 5 Å to 6.8 Å, the shell will preferably be a large pore zeolite or an intermediate pore size zeolite or an amorphous structure with large pores. In some embodiments, the pore size of the shell may be smaller than the materials in the feed stream to limit direct access to the core to passage through the macro porosity of the shell material.

The core-shell catalysts may incorporate an intermediate layer, such as MoO₃, between the core and the shell to stabilize binding sites for alkali metal poisons and block their interaction with the core. The catalyst shell can be designed with a carefully selected carrier material to improve active component dispersion and provide a protective environment that traps alkali poisons. Examples of carrier materials include hexagonal WO₃, nanotube structures, zeolite-based materials, porous carbon, three-dimensional graphene, multi-walled carbon nanotubes, and metal-organic frameworks.

The core-shell catalyst can comprise different amounts of core and shell materials with the ratio of core:shell of 0.5:1, 1:1, 2:1, 4:1, 7:1, 15:1, 25:1, 50:1, 100:1, or 1100:1 or from 0.5:1 to 1100:1, 1:1 to 100:1, 1:1 to 25:1, 1:1 to 15:1, 2:1 to 7:1, or 3:1 to 6:1, by mass. The core-shell catalyst may comprise a core and a shell in which the ratio of the shell thickness to the core diameter is 0.0001, 0.0001, 0.01, 0.05, 0.1, 0.25, 0.5, 1, or 2, or between 0.0001 to 0.25, 0.001 to 0.25, 0.01 to 0.25, 0.05 to 0.5, 0.1 to 2, or 0.25 to 1.

The methods used to prepare core-shell catalysts can tune the size of the core, any catalytic metal particles, dispersion of the catalytic metal-containing particles in the core, the porosity and aperture size of the shell, or the thickness of the shell to produce highly reactive and stable core-shell catalysts for use in the catalytic pyrolysis of hydrocarbonaceous materials. Numerous methods of preparing core-shell catalysts are known to those skilled in the art.

### Catalytic Pyrolysis Process

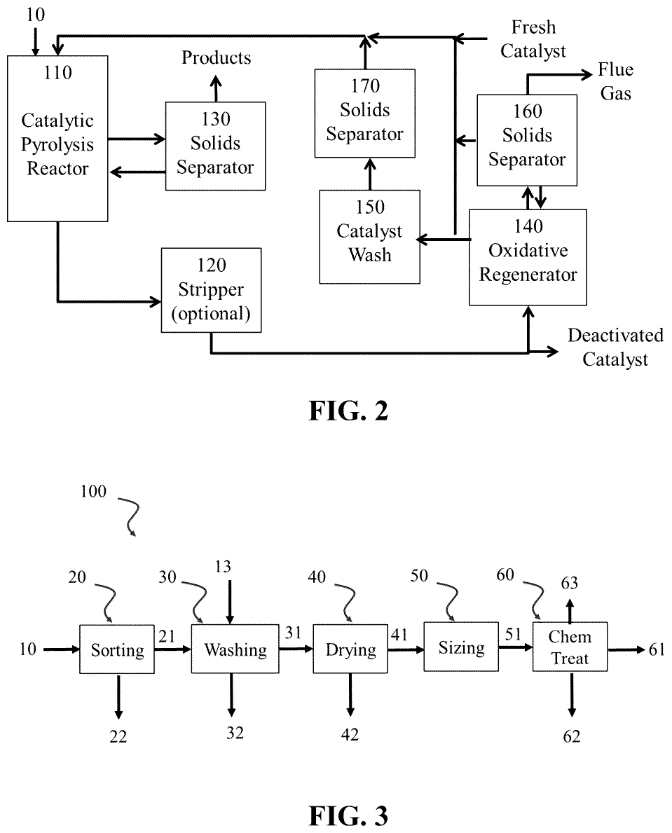

FIG. 2 shows a schematic of one embodiment of a catalytic pyrolysis process for producing valuable products from polymeric hydrocarbonaceous materials in which core-shell pyrolysis catalysts are utilized according to the present invention. A stream of polymeric hydrocarbonaceous materials 10 is introduced into a catalytic pyrolysis reactor 110 comprising a fluidized bed of catalyst. Carried along with the feed materials are small amounts of inorganic elements (halogens, alkali and alkaline earth metals, metal oxides), minor components such as Fe, Mg, Ti, and other materials. A fluidization fluid (not shown) is introduced to the pyrolysis reactor. In the pyrolysis reactor, the feed materials are pyrolyzed and catalytically converted into permanent gases, C2-C4 light olefins, C1-C4 light paraffins, and C5+ hydrocarbons including benzene, toluene, and xylenes (BTX), aromatic and non-aromatic naphtha range molecules, C11+ hydrocarbons, coke and char, and minor byproducts, mixed with the fluidization fluid. The vapor is passed to a solids separator 130 such as one or more cyclones where catalyst is separated and returned to the reactor and the vapor products are sent to product recovery and separation (not shown).

A portion of partially deactivated catalyst is continuously removed from the catalytic pyrolysis reactor. In an optional step, the used catalyst that has carbon deposits and minerals deposits on it is subjected to stripping/steaming in a stripper 120. In the optional stripping/steaming step, a flow of steam, inert gas, recycle gas, or some combination of these is passed over or through the spent catalyst and then added to the product stream (not shown).

The partially deactivated catalyst removed from the pyrolysis reactor 110 and/or optional stripper 120 is passed to a fluid bed oxidative regenerator 140. A portion of the deactivated and stripped catalyst may be discarded (“Deactivated Catalyst”). In the oxidative regenerator 140, the catalyst is exposed to an oxidizing fluidization gas, usually air, diluted air, or a CO₂ or steam-containing stream, or some combination of these, flowing into the oxidative regenerator 140 that is maintained at a temperature sufficient to cause combustion of at least a portion of the carbonaceous deposits on the catalyst. The oxidizing agent may originate from any source including, for example, a tank of oxygen, atmospheric air, or steam, or a portion of the vent gas from the regenerator, or some combination of these. In the oxidative regenerator, the catalyst is re-activated by reacting at least a portion of the carbon deposited on the catalyst with the oxidizing agent. In some embodiments, the oxidative regenerator may comprise an optional purge stream, which may be used to purge coke, ash, and/or deactivated catalyst from the oxidative regenerator.

The oxidative regenerator produces a vent vapor stream which may include regeneration reaction products, residual oxidizing agents, and/or inert gases, and entrained catalyst particles. The vapor stream exiting the oxidative regeneration is sent to a solids separator 160, such as one or more cyclones, where entrained catalyst is recovered and at least a portion of the recovered catalyst may be returned to the oxidative regenerator. Catalyst is continuously removed from the regenerator and a portion of the removed catalyst may be fed to optional catalyst wash step 150. The washed catalyst is separated from the wash or rinse solutions in a catalyst separator 170 and dried. The washed portion of the oxidatively regenerated catalyst and the remaining oxidatively regenerated catalyst may be fed to the catalytic pyrolysis reactor separately or together.

The flue gas vent stream from the regenerator may be passed through a catalytic exhaust gas cleanup system to further reduce the concentrations of CO and hydrocarbons to reduce emissions vented to the atmosphere. Portions of the vent stream may be recycled to the gas feed of the regenerator to control the heat release of the regeneration process (not shown). The oxidative regenerator may be fitted with a heat removal system such as a heat exchanger that produces steam, or other known heat removal system. Fuel and additional air may be introduced to the oxidative regenerator as an additional heat source. An external fired heater may be used to pre-heat the fluidization gas and oxidative agent before entering the regenerator. Methods for regenerating catalysts are well-known to those skilled in the art, for example, as described in Kirk-Othmer Encyclopedia of Chemical Technology (Online), Vol. 5, Hoboken, N.J.: Wiley-Interscience, 2001, pages 255-322.

The oxidative catalyst regeneration can comprise more than one step of oxidation carried out in one or more than one reactor. If more than one oxidative regeneration step is employed the second oxidative regeneration is conducted at a temperature higher than the first oxidative regeneration step.

An important feature of the oxidative regeneration process is that it is not required to rigorously remove all of the carbon on the catalyst since small amounts of coke may not significantly interfere with catalyst activity or selectivity. It also may be economically unattractive to remove the coke to such small quantities since the process would take longer and require longer catalyst residence time in the oxidative regenerator and larger volumes of regeneration gas etc.

The oxidative regenerator may be of any suitable size for connection with the reactor or the solids separator. In addition, the regenerator may be operated at elevated temperatures in some cases (e.g., at least about 550° C., 575° C., 600° C., 625° C., 650° C., 675° C., or higher). The temperature in the regenerator may be controlled so that the time-averaged maximum temperature in the regenerator is less than 750° C., 725° C., 700° C., 675° C., or 650° C. The temperature in the regenerator may be controlled so that the transient maximum temperature in the regenerator is less than 750° C., 725° C., 700° C., 690° C., 660° C., or 650° C. The residence time of the catalyst in the regenerator may also be controlled using methods known by those skilled in the art, including those outlined above. In some instances, the mass flow rate of the catalyst through the regenerator will be coupled to the flow rate(s) in the reactor and/or solids separator in order to preserve the mass balance in the system and/or to control the heat balance of the system.

A preferred type of apparatus for oxidatively regenerating a coke-contaminated, fluidized catalyst, comprises in combination: (1) a combustion chamber into which the coke-contaminated catalytic pyrolysis catalyst may be introduced and contacted with regeneration gas; (2) a disengagement chamber located adjacent to and above (with respect to gravity) the combustion chamber and in communication therewith; (3) optional heat removal apparatus comprising conduits containing heat absorbing fluid positioned within the combustion chamber, the conduits being sealed with respect to the interior of the combustion chamber such that the heat-absorbing material is in indirect heat exchanging contact with the interior of the heat removal chamber; (4) a regeneration gas inlet port connecting with a lower portion of the combustion chamber for introducing at least a portion of the regeneration gas into the lower portion of the combustion chamber below the level of the catalyst bed; (5) a catalyst exit conduit positioned above the regeneration gas inlet, and (6) a regeneration gas outlet port that allows the flue gas to exit the regeneration reactor. A suitable reactor is a fluidized bed reactor such as a bubbling bed or circulating bed. Catalyst to be regenerated may be introduced into the regenerator above the bed or below the bed with the fluidization fluid.

The regenerated catalyst may exit the regenerator via an exit port. The regenerated catalyst may be recycled back to the reactor via a recycle stream. In some cases, catalyst may be lost from, or intentionally removed from, the system during operation. Additional fresh makeup catalyst may be added to the system via a makeup stream. The regenerated and fresh catalyst may be fed to the reactor with the fluidization fluid via a recycle stream, although in other embodiments, the regenerated catalyst, the regenerated and washed catalyst, the makeup catalyst, and the fluidization fluid may be fed to the reactor via separate streams. The makeup rate of the addition of fresh catalyst to the system while removing a similar amount of used catalyst may be 0.5, 1.0, 1.5, 2.0, 2.5, 3.0, or 0.2 to 3.0, 0.5 to 2.5, or 1.0 to 2.0% by mass per day of the total catalyst in the system. In some embodiments the molar ratio of Ca or Mg or the sum of Ca and Mg in the shell of the catalyst in the system to Cl in the feed material processed during a 24-hour period is at least 100:1, 200:1, 250:1, 300:1, 500:1, or 1000:1, or from 100:1 to 5000:1, from 200:1 to 1000:1, or 250:1 to 500:1.

Catalytic pyrolysis is conducted in the absence of any added metals other than metals present in or on the catalyst or that enter as minor components of the feed. The temperatures in the catalytic pyrolysis reactor where catalyst is present are preferably in the range of 500° C. to 700° C., 520° C. to 600° C., 500° C. to 575° C., 550° C. to 600° C., 575° C. to 625° C., or 540° C. to 580° C., or at least 450° C., 500° C., 540° C., 550° C., or 575° C. The catalyst-to-hydrocarbonaceous feed mass ratio may be at least 0.5:1, 1:1, 2:1, 5:1, 10:1, 15:1, 20:1, 30:1, or higher in some embodiments, or from 2:1 to 50:1, 3:1 to 20:1, or 4:1 to 10:1. The residence time of gases or feed molecules in the catalytic pyrolysis reactor is at least 0.5, 1, 2, 5, 10, 30, 60, or 120 seconds, or in the range from 2 to 480, 5 to 240, 10 to 30, 0.5 to 10, 10 to 120, or from 30 to 60 seconds. The pressure in the catalytic pyrolysis reactor may be at least 1.1, 2, 4, or 10 bara, or from 0.5 to 10, 0.9 to 4, or from 1 to 2 bara.

Suitable fluidization fluids that may be used to fluidize the catalytic pyrolysis reactor in this invention include, for example, inert gases (e.g., helium, argon, neon, etc.), hydrogen, nitrogen, carbon monoxide, carbon dioxide, or a recycle stream, among others. The residence time of the fluidization fluid is defined as the volume of the reactor divided by the volumetric flow rate of the fluidization fluid under process conditions of temperature and pressure. In some cases, the residence time of the fluidization fluid may be at least about 0.2, 0.5, 1, 2, 5, 10, 30, 60, or 120 seconds, or in the range from 0.2 to 480, 0.5 to 240, 1 to 30, 0.5 to 10, 10 to 120, or from 30 to 60 seconds.

In some embodiments, at least a portion of the olefins in the fluid hydrocarbon product stream is separated from the product stream to produce a recycle stream, and the recycle stream is fed to the catalytic pyrolysis reactor to enhance production of aromatics and other products.

Throughout this specification, various compositions are referred to as process streams; however, it should be understood that the processes could also be conducted in batch mode. Examples of suitable apparatus and process conditions for catalytic pyrolysis are described in U.S. Pat. No. 8,277,643 of Huber et al., U.S. Pat. No. 9,169,442 of Huber et al., or U.S. Pat. No. 11,584,888 of Mleczko et al., which are incorporated herein by reference.

Suitable methods for separating and recovering aromatics from other fluid hydrocarbon products are known to those of ordinary skill in the art. For example, aromatics can be separated from other fluid hydrocarbon products by cooling the product stream, or a portion thereof, to a suitable temperature and a second separator that separates at least a portion of the aromatics from other gaseous products (e.g., gaseous aromatics, CO₂, CO, etc.) and from an aqueous product stream. The methods and/or conditions used to perform the separation can depend upon the relative amounts and types of compounds present in the fluid hydrocarbon product stream, and one of ordinary skill in the art will be capable of selecting a method and the conditions suitable to achieve a given separation given the guidance provided herein.

In one set of embodiments, catalyst removed from the catalytic pyrolysis reactor may contain significant quantities of organic compounds including aromatics and olefins. Prior to the step of oxidatively regenerating the catalyst, the catalyst removed from the catalytic pyrolysis reactor may be stripped of volatile materials by passing a stream comprising steam through the catalyst and collecting the products. The steam-containing stream that is used to strip the organics can be fed to the reactor, directed to the separation train, or otherwise be combined with product streams for recovery of the valuable organic compounds.

It should be understood that, while the set of embodiments described above includes a reactor, solids separator, regenerator, catalyst wash unit, etc., not all embodiments will involve the use of these elements. For example, in some embodiments, the feed stream may be fed to a catalytic reactor, reacted, and the reaction products may be collected directly from the reactor and cooled without the use of a dedicated condenser. In some instances, the product may be fed to a quench tower to which is fed a cooling fluid, preferably a liquid, most preferably a recycle stream, along with the product stream to cool and condense the products. In some instances, while a dryer, sizing system, solids separator, regenerator, catalyst wash unit, condenser, and/or compressor may be used as part of the process, one or more of these elements may comprise separate units not fluidically and/or integrally connected to the reactor. In other embodiments, one or more of the dryer, sizing system, solids separator, regenerator, condenser, and/or compressor may be absent. The desired reaction product(s) (e.g., liquid aromatic hydrocarbons, olefin hydrocarbons, gaseous products, etc.) may be recovered at any point in the production process (e.g., after passage through the reactor, after separation, after condensation, etc.).

The invention is generally applicable to any catalytic pyrolysis process. Preferably, the polymeric hydrocarbonaceous feedstock comprises a solid hydrocarbonaceous material. The feedstock may comprise, for example, any one or combination of the plastics sources that are mentioned in the Glossary section.

In this specification, where it is mentioned that contaminants (such as coke or minerals) are “deposited on” a catalyst, it of course includes the possibility that contaminants are deposited “in” a catalyst as well as “on” the catalyst. Typically, contaminants within pores of a catalyst are more difficult to remove and removal will take longer reaction times.

### Feed Pretreatment

FIG. 3 presents one embodiment of a pretreatment process 100 for pretreating waste materials to make them suitable for catalytic upgrading. The mixture of materials is introduced into an optional preliminary sorting system 20 that removes undesirable materials and rejects them in stream 22 and passes the useful materials 21 to a washing process 30. The sorting is often done manually or by any of a number of automated processes that include items such as screens and pickers or robotic mechanisms that are well known in the art. The undesirable materials 22 may include items such as metal, concrete, dirt, mineral matter, glass, or other material that is not readily processed along with hydrocarbonaceous materials. In the washing step 30, a solvent, water, or aqueous solution 13 is admixed with the solid materials, optionally agitated, and optionally heated, and the washed solids 31 are separated from the waste wash solution 32, rinsed with an aqueous solution (not shown), and passed to a drying unit 40. In some embodiments, the rinse can be conducted in the same vessel as the wash. In some embodiments the materials are washed on a moving conveyer rather than in a vessel by spraying wash solution on the materials and rinsed by spraying water on the washed materials. In the dryer 40 moisture and volatile solvents are removed by exposure to a flowing gas stream, optionally heated, or by condensation and passing out as a liquid 42. The dried material 41 is passed to a sizing unit 50. In the sizing unit, the materials are shredded by any of a range of cutting devices and large particles that do not pass through a sizing screen 52 are discarded or recycled to the preliminary sorting system 20, and the sized materials 51 are optionally passed to a thermal pretreatment unit 60. The thermal pretreatment process is preferably used with hydrocarbonaceous feed mixtures that comprise at least 80, 90, or 95% plastics by mass. In the thermal pretreatment unit 60, the material is heated to melt at least a portion of the plastics feed and drive off volatile off-gas products 63 such as H₂O, HCl, HBr, HI, NH₃, CO, CO₂, or other volatile decomposition products. Optionally, solid co-reactants (not shown), such as CaO, Ca(OH)₂, CaCO₃, CaSO₄, MgO, Mg(OH)₂, MgCO₃, MgSO₄, hydrotalcites, activated carbon, or zeolites, or some combination of these, that trap or remove undesirable components can be fed to thermal treatment reactor 60. The thermal pretreatment unit 60 may comprise one or more static mixers in which the molten mixture may be passed through a static mixing device to increase the homogeneity of the mixture. As part of the thermal pretreatment unit 60, the molten mixture may be passed through a screen or other filtering device to remove solids, added co-reactants, or fragments of material 62 that do not melt under the conditions of the process. The pretreatment process produces a stream 61 of pretreated material that can be cooled and chopped to an appropriate size for use in catalytic pyrolysis or kept hot and fed directly to a catalytic pyrolysis process.

The various units of the pretreatment process, i.e., 20, 30, 40, 50, and 60, can be re-arranged to suit the needs of the particular waste plastic mixture, the catalytic pyrolysis process, or other processes, or existing infrastructure, and may comprise any combination of these elements, or others as needed. In some cases, not all of these units will be needed, and some can be omitted. The washed material 61 comprises the feed to the catalytic pyrolysis process.

In embodiments wherein a solid co-reactant is fed to the thermal treatment reactor the separated solid co-reactant materials 62 are optionally transferred to a combustion regenerator (not shown) wherein the carbonaceous materials are reacted with air and at least a portion of the hot solid co-reactant material is returned to the thermal treatment reactor. In one embodiment of the invention the hot flue gas exiting the solid co-reactant regenerator is passed to a catalyst heater to heat the catalyst for the catalytic pyrolysis reactor or vented.

For feeds that comprise at least 70, 80, 90, or 95% by mass plastics, the pretreatment process may include an additional sizing, pelleting, agglomerating, densifying, or other particle shaping process step to produce waste plastic particles into cylindrical or roughly spherical shapes that are readily handled (not shown). A sizing process may involve shredding, cutting, chopping, or otherwise reducing the size of the material to particles with no dimension larger than 30 cm, 20 cm, 10 cm, 5 cm, 2.5 cm, 1 cm, 0.5 cm, or 0.2 cm. A pelleting process may involve feeding plastic waste materials such as stream 61 in FIG. 2 to an extruder where they are heated to form a molten mixture that is passed through an orifice. The resulting extrudate may be cooled and chopped or sliced into the desired size for transport and handling and feed to the pyrolytic upgrading process. An alternative pelleting process may involve stamping pellets from the solidified mixed plastic. Alternatively, suitable pellets of plastic may be produced by compressing particles of suitable size of the plastic mixture at an elevated temperature of at least 100° C. until enough softening occurs that the material binds together, and then cooling and chopping, cutting, or shredding the resulting mass to produce the desired size range of particles.

### Catalytic Pyrolysis Process Including Feed Pretreatment

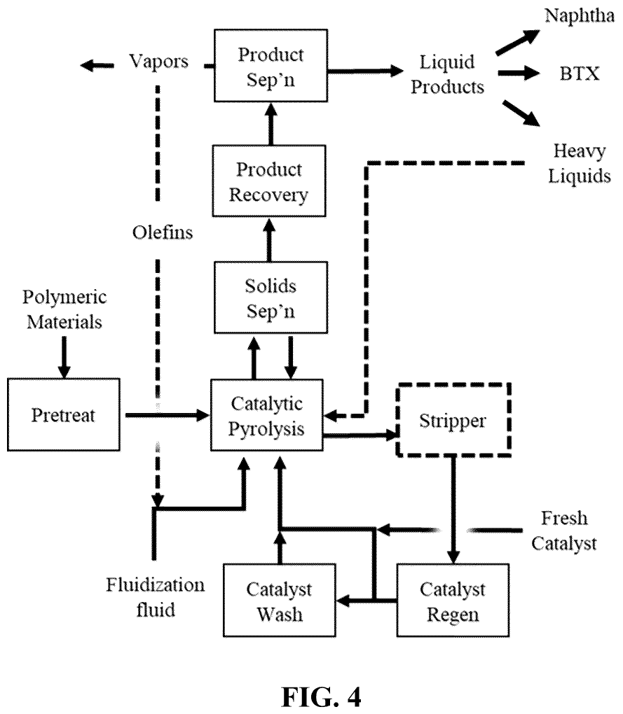

FIG. 4 depicts an embodiment of a process for pretreating and upgrading solid feed mixtures using a core-shell catalyst. A mixture of materials is introduced into a feed pretreatment system as depicted in FIG. 3, which may be one of a number of such pretreatment facilities that prepare the feed mixture for introduction into the process. The pretreated feed mixture may be in the form of pellets, irregular particles, or may be passed to the catalytic pyrolysis reactor as a melt. The pretreated feed mixture is passed to the fluid bed catalytic pyrolysis reactor that comprises a core-shell catalyst. A fluidization fluid is fed to the catalytic pyrolysis reactor and a product stream is removed and sent to a solids separator, product recovery, and product separation. Entrained catalyst is removed in the solids separation system and returned to the catalytic pyrolysis reactor while the products are sent to recovery and separation.

Catalyst is continuously withdrawn from the catalytic pyrolysis reactor and optionally sent to a stripper (dashed line) where it is steamed or stripped of organics that are sent to product separation (not shown). The catalyst is sent to a regenerator for oxidative regeneration. A portion of the oxidatively regenerated catalyst may be washed to remove contaminants and returned to the catalytic pyrolysis reactor either in combination with, or separate from, the balance of the oxidatively regenerated catalyst. A portion of the catalyst can be removed at any place in the process and fresh catalyst can be introduced along with the regenerated catalyst, the washed catalyst, or both, or separately. In product recovery the hot pyrolyzed vapor stream is quenched to separate the condensable products (liquids) from the vapor products and fixed gases. The liquid products are separated into various streams including naphtha, BTX, and one or more heavy liquid streams. Optionally a portion of the heavy liquids is recycled to the catalytic pyrolysis reactor (dashed line).

Optionally, an olefin-containing stream is separated from the vapor product stream and recycled to the catalytic pyrolysis reactor (dashed line), optionally in combination with the fluidization fluid. Optionally, the olefin-containing stream separated from the vapor product stream is sent to a product purification process to produce an olefin product stream or streams. The balance of the vapor stream is combusted to generate heat for the process or combusted to generate electricity or sent to flare. In some embodiments, a stream of hydrogen is separated from the vapors for use elsewhere in the process or as a product.

### Catalyst Washing

Contaminants that adhere to the catalyst may be removed in a washing step. Typically, the catalyst that is rejuvenated in a washing step is first regenerated in one or more oxidative regeneration stages (usually the oxidative regeneration comprises combustion) as described above. The oxidatively regenerated catalyst may then be treated to remove ash or catalyst fine particles or both, for example, by passage through one or more cyclone separators. Typically, it will be necessary to remove heat from the oxidatively regenerated catalyst prior to a washing step, and this heat is preferably at least partly recovered, for example, by preheating a fluidizing gas of the oxidative regeneration gas or of the catalytic pyrolysis reactor; likewise at least a portion of gas that is used to cool the oxidatively regenerated gas can be used as a fluidizing gas for the pyrolysis reactor or catalyst regenerator.

In the catalyst washing step at least a portion of the oxidatively regenerated catalyst is washed with a solution that at least partially removes the elements that have deposited on or in the catalyst, either in the core, the shell, or both. In the washing step the catalyst is treated by washing with a liquid washing solution that at least partially removes the elements or salts that are deposited thereon including but not limited to Ca, Mg, K, Na, F, Cl, Br, I, Fe, Mn, S, Ti or combinations thereof. The solution can be any solution including water, acidic water, water with surfactants, water with multi-dentate ligands such as EDTA, polyvinylalcohol, oxalic acid, citric acid, or any other material that removes the mineral elements without damaging the catalyst structure or removing significant quantities of catalytically active elements or promoters or damaging the binder. Preferred solutions include mineral acids such as nitric acid, sulfuric acid, phosphoric acid, or some combination thereof, but not limited to these. Other washing solutions can be used including alcohols, ethers, organic acids, amines, supercritical CO₂, or other materials, or any of these materials in water solution. The washing process can be operated at any temperature of at least 15, 20, 35, 50, or 90° C., or from −20 to 200, from 20 to 100, or from 25 to 75° C. depending on the nature of the mineral to be removed, the solvent, and the catalyst. The pH of the wash solution can be less than 5, 4, 3, 2, or 1, or from 0.01 to 5, 0.01 to 2.5, or 0.1 to 2. The washing may be done under pressure, with absolute pressures of at least 1.1, 2, 4, or 10 bara, or from 0.5 to 10, 0.9 to 4, or from 1 to 2 bara.

In some embodiments the entire catalyst from an oxidative regeneration step is subjected to washing. In some other preferred embodiments, only a portion, such as 0.1 to 10%, 1 to 50%, 2 to 40%, 5 to 35%, or 10 to 30%, or less than 50%, 25%, 10%, 5%, or less than 1%, of the oxidatively regenerated catalyst is washed. The washing process need not be conducted after each time the catalyst passes through the reactor and is regenerated oxidatively, in some embodiments the washing could be used with catalyst that has passed through the reactor many times and oxidatively regenerated, i.e., washed only after 1 to 1000 cycles, or 2 to 500 cycles, or 10 to 200 cycles, or 10 to 100 cycles, or at least 10 cycles, or at least 50 cycles, or at least 100 cycles through the reactor and oxidative regenerator, thus making the process more efficient and saving energy. The washing process need not be conducted during the entire time the catalytic pyrolysis process is being conducted. The washing process can be conducted intermittently, i.e. the washing process can be conducted in a continuous manner for a time and then not conducted for a time. In some embodiments, a portion of the catalyst is separated from the remainder of the oxidatively regenerated catalyst and subjected to the washing step before being returned to the reactor. This would allow removal and treatment of a side stream to reduce the size of the equipment. It also maintains a portion, preferably the majority of the catalyst, at high temperature for recycle to the reactor; thus, reducing the requirement for reheating any washed catalyst. In some embodiments the catalyst is treated with an optional treatment step before the washing step such as sifting or air classification to remove fines and the lighter weight ash particles before washing the catalyst. Removal of the fines may facilitate the washing step by making it easier to separate the washed catalyst from the wash solution when the content of fines is reduced. In some embodiments, a portion of the fines removed before the washing step is returned to the reactor.

After washing is completed, the catalyst is rinsed with water, deionized water, distilled water, or an aqueous solution with less than 25 ppm of K, 25 ppm of Na, 100 ppm of Ca, and less than 100 ppm of Mg or other aqueous solution, and preferably recovered by filtration or centrifugation, which, in some embodiments, is followed by heating, for example, to remove water and residual wash solution materials (in the case where heating reaches high temperatures). Any process for solids separation can be used to remove the catalyst from the wash solution such as gravity filtration, centrifugal filtration, pressure filtration, vacuum filtration, or others. Solid-liquid separation processes are well known to those skilled in the art, such as in Solid-Liquid Separation (Fourth Edition), Svarovsky, ed. 2001 Elsevier, incorporated herein by reference.

In preferred embodiments wherein the shell of the core-shell catalyst comprises Ca, Mg, or both Ca and Mg, a portion of the Ca or Mg may be removed from the catalyst by washing. In such cases, the shell of the catalyst may be replenished by coating the washed material with a fresh coating of Ca or Mg materials. The shell replenishment process may be a solution impregnation, spray drying, deposition, dip-coating, spin-coating, casting, filtration, layer-by-layer assembly, or by fluidization of the core with dust of the shell, or any combination of these.

An important feature of the washing process is that it is not required to rigorously remove all of the mineral materials since small amounts of these materials, i.e., 1 ppm to 10% (based on total catalyst mass) may be useful to improve the catalyst life and stability or may not significantly interfere with catalyst activity, stability, or selectivity. It also may be economically unattractive to remove the minerals to such small quantities since the process would take longer and consume more solvents etc. With a core-shell catalyst, the washing process can be operated to remove impurity elements from the shell without impacting the core of the catalyst to enhance the ability of the shell to retard catalyst deactivation. Prior to the washing step, catalyst that has been used for the catalytic pyrolysis may contain 10%, 8%, 5%, 4.0%, 3.0%, or 2.0 mass % or more F, Cl, Br, I, Ca, Mg, K, or Na or the sum of these depending on reaction conditions, length of exposure to feed materials, and catalyst type, all when expressed as oxides. In some embodiments the Ca remaining on the catalyst after washing can be 2.0%, 1.0%, 0.6%, 0.3% 0.2%, 0.1%, 5000 ppm, 1000 ppm, or 250 ppm or less, or 0.0001 to 2.5%, 0.01 to 1.0%, or 0.2 to 2.0% when expressed as oxide. In some embodiments the Mg remaining on the catalyst after washing can be 2.0%, 1.0%, 0.6%, 0.3% 0.2%, 0.1%, 5000 ppm, 1000 ppm, or 250 ppm or less, or 0.0001 to 2.5%, 0.01 to 1.0%, or 0.2 to 0.5% when expressed as oxide. In some embodiments the K remaining on the catalyst after washing can be 2.0%, 1.0%, 0.6%, 0.3% 0.2%, 0.1%, 5000 ppm, 1000 ppm, or 250 ppm or less when expressed as oxide. In some embodiments the Ti or Fe remaining on the catalyst after washing can be 2.0%, 1.0%, 0.6%, 0.3% 0.2%, 0.1%, 5000 ppm, 1000 ppm, or 250 ppm or less when expressed as oxide. In some embodiments the S remaining on the catalyst after washing can be 2.0%, 1.0%, 0.6%, 0.3% 0.2%, 0.1%, 5000 ppm, 1000 ppm, or 250 ppm or less.

In some embodiments promoter elements such as Ga, Zn, Co, Fe, Cr, Cu, V, Ni, Mn, Ag, Na, P, Sn, Zr, Nb, Y, Ti, Ce, La, or combinations thereof, can optionally be re-introduced into the catalyst after (or simultaneous with) the extraction step. In other embodiments halogen trapping elements such as Ca or Mg can be re-introduced. This could be done by impregnation with an aqueous solution, a solution in an organic solvent, or other means. The active elements can be introduced as components of a makeup catalyst.

The process of the present invention regenerates Brønsted acid sites in the catalyst core to restore activity and selectivity for aromatics production. In some embodiments of this invention, the regeneration process restores the Brønsted acid sites (or Brønsted acid site density) to at least 70%, 75%, 80%, 100%, or at least 120%, or from 70% to 170%, 75% to 150%, or from 80% to 140% of the number of Brønsted acid sites (or site density) found in the fresh catalyst as determined in an IPA-TPD experiment. The process of the present invention can regenerate the Brønsted acid site density (mmol/kg) of the catalyst after washing to at least 30, 40, 50, 60, 70, 75, 80, 85, 90, 95, 100, or 110, or from 70 to 140, or from 80 to 120 mmol/kg as measured by an IPA-TGA adsorption experiment.

The IPA-TPD experiment is the technique by which Brønsted acid sites are determined in the present invention. In the desorption curve of an isopropyl amine temperature programmed desorption (IPA-TPD) experiment, the sharp desorption at 270-380° C. is assigned to IPA decomposition into propylene and NH₃ occurring on the Brønsted acid sites. The peak area under the desorption curve measured from 270 to 380° C. is used for quantifying the number of Brønsted acid sites for a particular sample. The desorption curve measured from 130-270° C. is assigned to weak acid sites. Whilst not wishing to be bound by theory, it has been observed that the Brønsted acid sites on the catalyst appear to be active for the preferred conversion of hydrocarbonaceous materials to aromatics, whereas the weak acid sites are not as important. Weak acid sites in the shell are advantageous in the ability of the shell to inhibit catalyst poisoning, or holding Ca or Mg, however, so that regeneration of these sites improves the ability of the shell to limit catalyst poisoning.

In some embodiments, a catalyst wash unit comprises a Soxhlet extractor. In some other embodiments, the catalyst wash unit comprises a stirred tank, a rotary mixer, a sprayed conveyor belt, a slurry bubble column reactor, a Pachuca tank or a rotary disk in which the catalyst is treated in several stages of washing. Apparatus and methods for contacting solutions with catalysts are known to those skilled in the art.

### Catalyst Activity Management System.

Catalytic fluid bed conversion of polymeric hydrocarbonaceous materials to valuable products has similarities to fluid catalytic cracking (FCC), a major process used in oil refining to convert heavy gas oils into lower molecular weight products. Similar to FCC, the catalytic pyrolysis process uses a fluid bed of catalyst comprising a solid acid zeolite to catalytically crack the molecules. Coke is deposited on the catalyst in the reactor, and the catalyst is burned clean of much of these deposits in a parallel operating regenerator. The reactor and regenerator exchange slip streams of catalyst between them and the entire process operates at essentially steady state with respect to catalyst activity. Contaminants in the feeds, such as alkali or alkaline earth metals, other metals, or halogens can accumulate on the catalyst causing deactivation. To manage catalyst losses and manage the catalytic activity of the entire system including deactivation caused by contaminants, small amounts of circulating catalyst (called “E-cat” to indicate that the catalyst activity has “equilibrated” to a steady state of activity with respect to catalyst deactivation) are removed and the removed catalyst and any other losses are replaced with fresh catalyst having full activity.

Based on the similarities with FCC, the maximum level of impurity elements that interfere with the catalyst activity, typically K, Na, Ca, Mg, or their combination, which are allowed to deposit on or in the catalyst particle in the catalytic pyrolysis process can be estimated, such that the catalyst make-up rate becomes less expensive and within the bounds of conventional practice, while still maintaining adequate catalyst activity for conversion of reactants. For equilibrated ZSM-5 catalyst of the type used for the catalytic pyrolysis processes of the present invention, a target of ≤600 ppm K (or an equimolar amount of Na, or the sum of Na and K) deposited on or in the zeolite particles (core) at steady state can be calculated. This corresponds to a loss of ≤8% of the available acid sites on the catalyst. The catalyst formulation plays a role in the determination of the acceptable level of alkali deposition and consequently the maximum allowable alkali in the feedstock. Catalyst composition variables of importance include the silica/alumina molar ratio of the ZSM-5 or other zeolite, and the percent of zeolite crystal in the catalyst matrix materials. In general, lower silica/alumina ratio and higher zeolite weight percent loading result in more acid site density, and greater capacity to exchange with alkali, i.e. greater tolerance for alkali deposition without significant loss of acidity and activity. In FCC, typically acceptable catalyst make-up rates (fresh catalyst addition per day) are on the order of 1-3% per day of the catalyst inventory to minimize catalyst costs and improve the economics of the process.

Particularly in the pyrolysis of plastics, halogen-containing materials such as PVC, or PVDC, or others, may release halogens that may contaminate, deactivate, or degrade catalysts, or corrode the reactor system, or both. A catalyst replacement scheme similar to that used in FCC can be used for controlling or inhibiting the impact of halogens, i.e. the process is operated by replacing a portion of the spent catalyst with fresh makeup catalyst regularly to maintain the halogen concentration (F, Cl, Br, or I, or some combination thereof) on the catalyst below some level at which it degrades the catalyst. For chlorine, the maximum allowable amount of chlorine on the catalyst is about 500 ppm of chlorine (about 14.1 mmol Cl per kg of catalyst); the maximum allowable mass fraction of halogen would be different for F, Br, or I in proportion to their atomic masses. In some embodiments a catalyst activity management system can be arranged such that the concentration of chlorine on the catalyst is maintained at no more than 10, 25, 50, 100, 200, 300, 400, 500, 750, 1000, or 2000 ppm by mass of chlorine, or no more than 0.28, 0.7, 1.4, 2.8, 5.6, 8.4, 11.0, 14.1, 21.1, 28.2, or 56.4 mmol of F, Cl, Br, or I, or some combination of F, Cl, Br, and I, per kg of catalyst, or from 0.28 to 56.4, 0.7 to 28.2, or 1.4 to 5.6 mmol of halogens per kg of catalyst.

The thickness of the shell may be controlled to ensure that sufficient material is available to react with the halogens in the feed to the process.

Core-shell catalytic pyrolysis catalysts can form one part of a catalyst activity management system that provides much longer-lived catalysts, reducing costs, catalyst inventories, corrosion, waste streams, and catalyst handling functions. In an embodiment of the invention a catalyst activity management system comprises 1) a feed system for introducing feed materials comprising at least 50% by mass plastics into the system, 2) a pretreatment system for pretreating at least a portion of the feed materials, 3) a fluid bed catalytic pyrolysis reactor comprising a core-shell catalyst in which the feed is pyrolyzed in the presence of the catalyst, 4) a catalyst regenerator wherein catalyst removed from the reactor is oxidatively regenerated, 5) a conduit for removing and discarding spent catalyst and a conduit for admitting fresh catalyst, 6) a catalyst wash system wherein at least a portion of the catalyst is washed either before or after oxidative regeneration, 7) an optional catalyst refurbishment system in which catalyst may be refurbished by adding shell materials to the catalyst, 8) a solids separation system for separating solids from vapor products of the catalytic pyrolysis, and 9) a product recovery system for recovering aromatics, olefins, paraffins, and other valuable materials from the product stream.

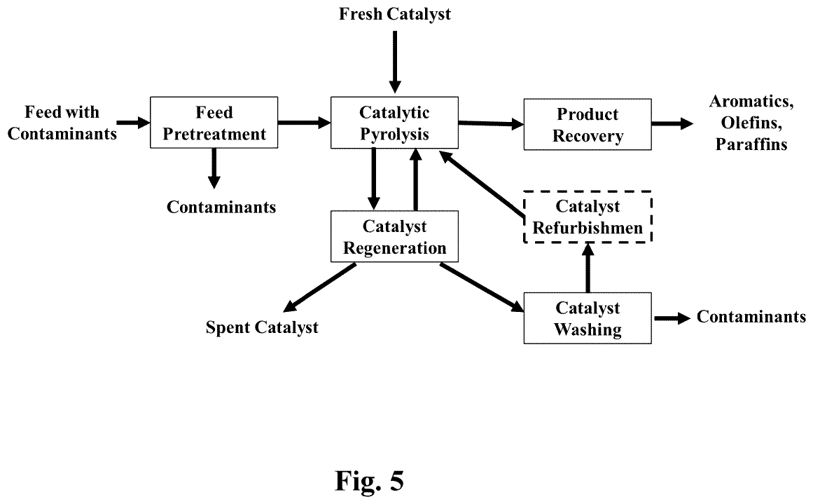

FIG. 5 shows a schematic of one embodiment of a catalyst activity management system for producing valuable products from plastics, waste materials, and other polymeric hydrocarbonaceous materials using core-shell catalysts. A stream of hydrocarbonaceous feed materials is introduced into a feed pretreatment system. In the feed pretreatment system, the feed material is pretreated which at least comprises washing with an aqueous acidic (or other) solution to remove contaminants and then dried. The pretreated material is passed to a catalytic pyrolysis reactor comprising a fluidized bed of core-shell catalyst. In the pyrolysis reactor, the feed is pyrolyzed and catalytically converted into permanent gases, C2-C4 light olefins, C1-C4 light paraffins, and C5+ hydrocarbons including benzene, toluene, and xylenes (BTX), aromatic and non-aromatic naphtha range molecules, C11+ hydrocarbons, coke and char, and minor byproducts, mixed with the fluidization fluid. The product vapor is passed through one or more cyclones (not shown) where catalyst is separated and returned to the reactor and the vapors are sent to product recovery and separation (not shown). A stream of catalyst is removed from the reactor and passed to a catalyst regenerator in which the catalyst is subjected to oxidative regeneration to remove coke and char. Optionally, before it is oxidatively regenerated, the catalyst removed from the reactor may be treated with a stream of steam to remove and recover volatile products. A slip stream of oxidatively regenerated catalyst is optionally washed with an acidic aqueous solution to remove contaminants and dried. The washed catalyst may be refurbished by addition of Ca, Mg, or both Ca and Mg containing, or other materials that form a portion of the shell of the catalyst. The oxidatively regenerated, washed catalyst, and any refurbished catalyst portions are returned to the catalytic pyrolysis reactor. A portion of the spent catalyst may be removed from the process at any point and replaced by adding fresh makeup catalyst to the catalytic pyrolysis reactor on a continuous basis. The amount of fresh catalyst that replaces spent catalyst is an amount such that the molar amount of Ca, Mg, or Ca and Mg in the shell of the fresh catalyst added to the reactor is at least equal to 0.5, 0.75, 1, 1.5, or 2, or from 0.5 to 5, 0.5 to 3, or 0.5 to 2 times the molar amount of halogens fed to the process in a day.

### EXAMPLES

### Example 1

A mass balance model was developed to calculate the amount of an impurity element(s) that would be deposited on the catalyst at steady state as a function of the feedstock impurity content and the catalyst makeup rate. Alkali metals are the elements that have the greatest impact on poisoning catalyst activity, so potassium was chosen as the representative poison in the model. It was assumed that the core zeolite and the acidic shell would each absorb some of the potassium and that the K would be washed out of the shell more readily than out of the core. It was assumed that 25% of the K in the feed is deposited on the zeolite core in a single pass through the fluid bed reactor, and that the balance of the K deposits on the acidic shell material. Calculations were conducted on cases in which the shell could reduce the deposition of K on the core by 40% or 80%. Based on similarities to FCC, maintaining the K on the catalyst at no more than 600 ppm was used as the goal.

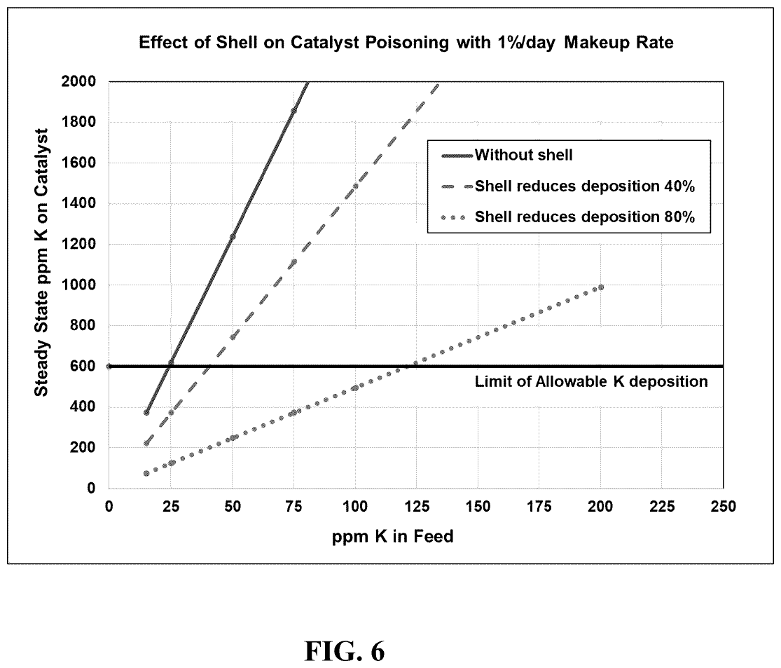

The results of the model with a 1% makeup rate of catalyst are shown in FIG. 6 (steady state K deposition on catalyst as a function of K content of feedstock). From FIG. 6, to maintain the catalyst at a steady state K content of 600 ppm K or less and a makeup rate of 1%, a feedstock containing at most 25 ppm K will be required to maintain the activity of the catalyst without a shell. FIG. 6 shows the impact of the shell reducing the deposition of K on the catalyst by 40% or 80%, where feedstock with K content of 40 ppm K and 125 ppm K can be used while maintaining the K content of the core of the core-shell catalyst at steady state of 600 ppm.

The results of Example 1 show that a core-shell catalyst improves the tolerance of a catalytic pyrolysis process for upgrading polymeric hydrocarbonaceous materials, and that a feed with a larger impurity content can be used with the core-shell catalyst than a catalyst without an external coating (shell).

### Example 2

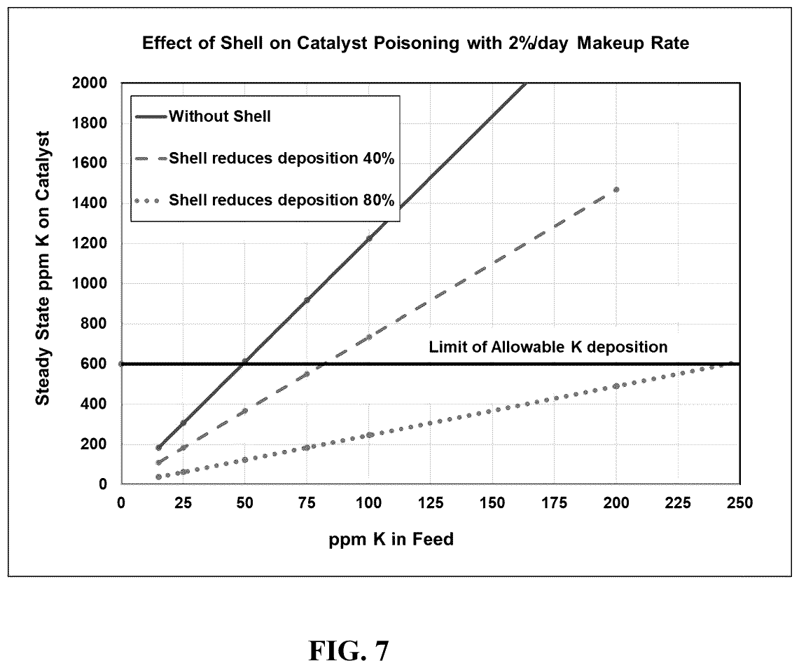

In Example 2 the model was exercised as in Example 1 except a 2% per day catalyst makeup rate is assumed. The results are presented in FIG. 7. In this case, the allowable K content in the feed is as much as 50 ppm K for a catalyst without a shell. For a core-shell catalyst in which the K deposition is reduced by 40%, the allowable K in the feed is 80 ppm, and for a shell that reduces K deposition by 80% the allowable K content in the feed is 250 ppm. The results of Example 2 show that a core-shell catalyst improves the tolerance of a catalytic pyrolysis process for upgrading polymeric hydrocarbonaceous materials, and that a feed with a larger impurity content can be used with the core-shell catalyst than a catalyst without an external coating (shell).

### Example 3

A mathematical model was developed to determine the thickness of the shell that would be required to trap the chlorine in a feed containing small amounts of chlorinated plastics, e.g. PVC. In this model the shell was assumed to contain calcium as either CaO, Ca(OH)₂, CaCO₃, or CaSO₄. For each of these model shells the shell was assumed to be composed of a 50:50 by mass mixture of the calcium compound and an inert binder of a similar density. It was assumed that the shells are porous and that 100% of the chlorine reacts with the calcium in the shell to form CaCl₂. The make-up rate was assumed to be either 1% or 2% per day, and the catalyst to feed ratio was set to 6:1. The catalyst particles were assumed to have a core with a diameter of 75 μm (1 μm=1.0×10⁻⁶ m) and shell thicknesses of 0.05, 0.1, 0.5, 1, 2, 5, and 10 μm in thickness were evaluated.

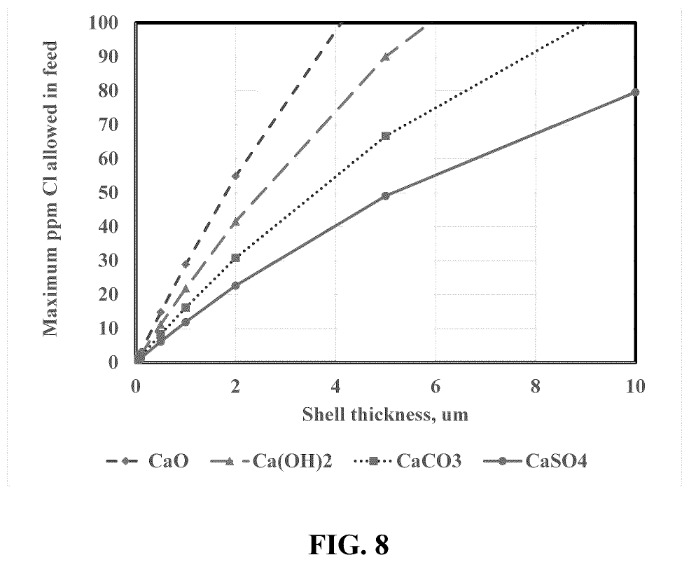

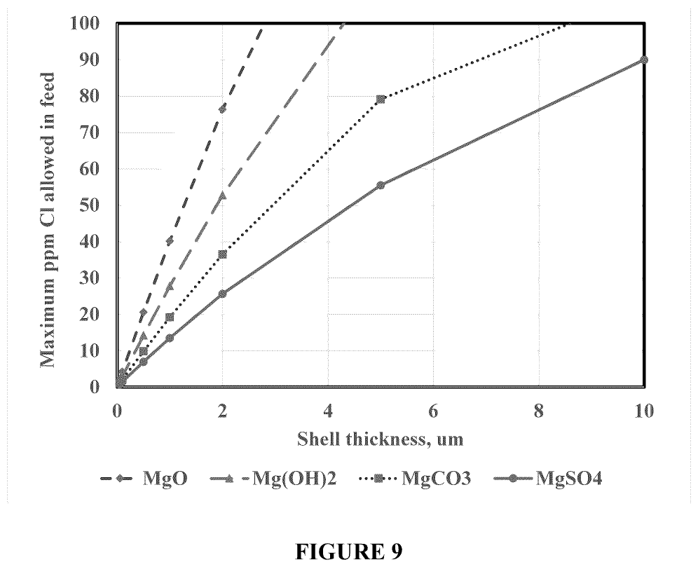

The model calculates the amount of Cl that can be trapped by shells of different thicknesses. From this, one can determine the thickness of the shell that would be needed so that the chlorine absorbed by the shell would be replaced with fresh shell material in the makeup catalyst, i.e. the Ca in the makeup equals the Cl in the feed at a 1:2 ratio (CaCl₂ formed). The results provide the maximum Cl content that is allowable in the feed for a particular thickness of shell in order to trap all the chlorine so that no chlorine reaches the core of the catalyst. The results of the model for the 1%/day makeup rate are presented in FIG. 8 for shells that contain 50% by mass CaO, Ca(OH)₂, CaCO₃, or CaSO₄. The shell material that contains the largest mass fraction of Ca is CaO, which is 71.5% Ca, so a catalyst with CaO in the shell can tolerate the largest amount of Cl in the feed. For a catalyst with a 4 μm thick shell, the catalyst with the CaO can tolerate 98 ppm Cl, Ca(OH)₂ can tolerate 72 ppm Cl, CaCO₃ can tolerate 54 ppm Cl, and CaSO₄ can tolerate 40 ppm Cl. For a feed that contains 20 ppm Cl, the shells need to be 0.7 μm thick for CaO, 0.9 μm for Ca(OH)₂, 1.3 μm for CaCO₃, and 1.8 μm thick for CaSO₄.

The same calculation was executed for a makeup rate of 2% per day with the same core-shell catalysts. The results are collected in TABLE 1.

TABLE 1
Maximum allowable Cl content in the feed with Ca-containing core-
shell catalysts using 2% per day addition of makeup catalyst.

| Active | | | | | |
|---|---|---|---|---|---|
| Material | Particle | | | | |
| Shell | w/shell | 50% Ca(OH)₂ | 50% CaCO₃ | 50% CaSO₄ | 50% CaO |
| Thickness | Diameter | in Shell | in shell | in shell | in shell |
| μm | μm | ppm | ppm | ppm | ppm |
| none | 75.0 | | | | |
| 0.05 | 75.1 | 2.3 | 1.7 | 1.2 | 3.0 |
| 0.1 | 75.2 | 4.6 | 3.4 | 2.5 | 6.0 |
| 0.5 | 76.0 | 22.4 | 16.6 | 12.2 | 29.6 |
| 1.0 | 77.0 | 43.7 | 32.3 | 23.8 | 57.7 |
| 2.0 | 79.0 | 83.0 | 61.4 | 45.2 | 109.7 |
| 5.0 | 85.0 | 180.0 | 133.3 | 98.0 | 237.8 |
| 10.0 | 95.0 | 292.1 | 216.2 | 159.0 | 385.9 |

The analysis for other halogens F, Br, or I are similar, adjusted for the atomic weights of these elements. For F (atomic mass 19) the allowable F is 19/35.5 of that for chlorine. Similarly, for Br the tolerance is 79.9/35.3 of that for chlorine, and for iodine the tolerance is 126.9/35.5. The results show that core-shell catalysts with calcium-containing shells increase the tolerance of the process to chlorine in the feed with shell thicknesses as thin as one micrometer.

### Example 4

The analysis of Example 8 was adapted to magnesium as the chlorine trap. In this case the thickness of the protective shell can be adjusted by the molecular mass of magnesium compounds that provide the same number of Mg atoms. For example, for a shell that contains 50% MgO, the adjustment is based on the relative molecular weights of MgO (40.3) and CaO, (51.5), so the thickness of the shell will be about ⅘ of that required with CaO, or, conversely, a shell with Mg of the same thickness as a Ca-containing shell will trap more Cl.

The calculation was repeated with a 2% per day makeup rate. The results appear in TABLE 2.

TABLE 2
Maximum allowable Cl content in the feed with Mg-containing core-
shell catalysts using 2% per day addition of makeup catalyst.

| Active | Particle | | | | |
|---|---|---|---|---|---|
| Material Shell | w/shell | 50% Ca(OH)₂ | 50% CaCO₃ | 50% CaSO₄ | 50% CaO |
| Thickness | Diameter | in Shell | in shell | in shell | in shell |
| μm | μm | ppm | ppm | ppm | ppm |
| none | 75.0 | | | | |
| 0.05 | 75.1 | 2.9 | 2.0 | 1.4 | 4.2 |
| 0.1 | 75.2 | 5.8 | 4.0 | 2.8 | 8.4 |
| 0.5 | 76.0 | 28.5 | 19.7 | 13.8 | 41.2 |
| 1.0 | 77.0 | 55.5 | 38.4 | 26.9 | 80.2 |
| 2.0 | 79.0 | 105.5 | 72.9 | 51.1 | 152.6 |
| 5.0 | 85.0 | 228.7 | 158.2 | 110.9 | 330.9 |
| 10.0 | 95.0 | 371.2 | 216.2 | 179.9 | 536.9 |

### Example 5

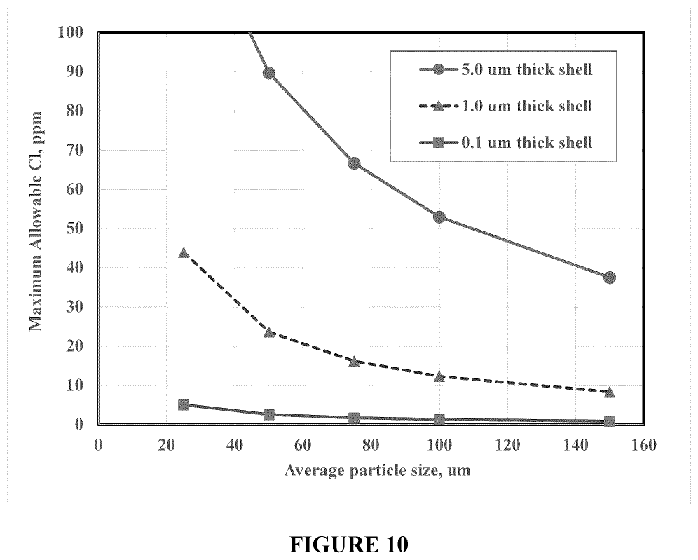

The model was used to calculate the shell thicknesses required for different particle size materials with shells that were derived from 50% CaCO₃ and a process operated with a 1% per day makeup rate. The results for average particle diameters of 25, 50, 75, 100, and 150 μm are collected in FIG. 10.

The results in FIG. 10 show that for smaller particle sizes using the same shell thickness the core-shell catalyst is more tolerant to Cl, i.e. more Cl can be trapped than for larger particles. With smaller particles, of course, the same thickness shell occupies a larger fraction of the mass and volume than it does for larger particles.

1. A process for producing valuable products by catalytically pyrolyzing polymeric hydrocarbonaceous materials, comprising:
contacting a stream comprising at least 50 wt % plastics with a core-shell catalyst in a fluid bed catalytic reactor,
wherein the core-shell catalyst comprises catalyst particles comprising:
at least one core particle comprising a zeolite, and
a shell which encapsulates or covers at least a portion of a surface of the at least one core particle;
recovering paraffins, olefins, or aromatics or some combination thereof from a product stream; and
(a) wherein the shell has a thickness of from 0.01 to 100 microns (μm); or
(b) wherein the core-shell catalyst comprises a plurality of core particles dispersed in a matrix material wherein the matrix material comprises at least 5 mass % Ca.

2-5. (canceled)

6. The process of claim 1, wherein the process is carried out in apparatus comprising:
a feed mechanism for passing feed into a reactor fitted with a catalyst,
an outlet for products to pass out of the reactor,
a solids separator that separates solids from the product stream exiting the reactor and returns the solids to the reactor,
an optional steam stripper to remove materials from the used catalyst,
a regenerator for oxidatively regenerating the catalyst,
a conduit for transporting solids from the reactor to the regenerator,
a conduit for transporting solids from the regenerator to the reactor,
an exit port on the regenerator to permit exhaust of flue gas,
a product condenser to condense heavy products from the product stream, and
a product collection and separation train to separate products into valuable fractions such as BTX, olefins, paraffins, and non-condensable gases.

7. (canceled)

8. The process of claim 1 wherein the core or shell of the core-shell catalyst comprises a zeolite, WOₓ/ZrO₂, or aluminum phosphate.

9. (canceled)

10. (canceled)

11. The process of claim 1 wherein:
the shell or matrix of the core-shell catalyst comprises one or more material selected from among silica, alpha-, beta-, or gamma-alumina, activated alumina, cerium oxide, titanium dioxide, zirconia, gallium oxide, zinc oxide, hafnium oxide, yttrium oxide, lanthanum oxide, or any combination thereof, or any of these oxides that have been doped with Ca or Mg, or
the shell or matrix of the core-shell catalyst comprises one or more material selected from among clay minerals, layered silicate minerals, or a material derived from a layered double hydroxide, or any combination thereof.

12-14. (canceled)

15. The process of claim 1 wherein the shell of the core-shell catalyst has a silica to alumina mole ratio less than the silica to alumina mole ratio of the core, and is less than 200:1, 100:1, 50:1, 30:1, or 2:1.

16-17. (canceled)

18. The process of claim 1 wherein the shell of the core-shell catalyst is applied to the core by fluidizing the core with particles of shell material in the catalytic pyrolysis reactor.

19. (canceled)

20. The process of claim 1 wherein the process is operated with a makeup rate of fresh catalyst added to a system fluid while removing a similar amount of used catalyst of 0.5, 1.0, 1.5, 2.0, 2.5, 3.0, or 0.2 to 3.0, 0.5 to 2.5, or 1.0 to 2.0% by mass per day of the total catalyst in a system.

21. The process of claim 20 wherein the amount of fresh catalyst that replaces spent catalyst in a day is an amount such that a molar amount of Ca, Mg, or Ca and Mg in the shell of the fresh catalyst is equal to at least 0.5, 0.75, 1, 1.5, or 2, or from 0.5 to 5, 0.5 to 3, or 0.5 to 2 times the molar amount of halogens fed to the process in a day.

22-27. (canceled)

28. The process of claim 1 wherein the core-shell catalyst comprises a plurality of core particles dispersed in a matrix material wherein the matrix material comprises at least 5 mass % Ca.

29. The process of claim 1m comprising:
pretreating at least a portion of the stream comprising at least 50% by mass plastics to remove impurities.

30. (canceled)

31. The process of claim 29 wherein pretreatment comprises:
separating, sorting, or grading by type or size of material, or,
washing, with solvent or water or aqueous solution, and drying, or,
sizing into sizes more amenable to further processing, or,
contaminant removal by thermal or chemical or both thermal and chemical treatment, or some combination thereof.

32-33. (canceled)

34. The process of claim 29 wherein feed material is heated to melt at least a portion of the plastics feed and drive off volatile off-gas products comprising one or more of H₂O, HCl, HBr, HI, NH₃, CO, or CO₂.

35. The process of claim 29 wherein the feed mixture is heated along with one or more solid co-reactants chosen from among CaO, Ca(OH)₂, CaCO₃, CaSO₄, MgO, Mg(OH)₂, MgCO₃, MgSO₄, hydrotalcites, activated carbon, or zeolites, or some combination of these, and the molten mixture is filtered to remove solids.

36. The process of claim 29 wherein the pretreatment process includes a sizing, pelleting, agglomerating, densifying, or other particle shaping process step to produce waste plastic particles of cylindrical or spherical shapes,
wherein particles are compressed at an elevated temperature of at least 100° C. until enough softening occurs that the material binds together, and then cooled and sized by chopping, cutting, or shredding the resulting mass to produce the desired size range of particles, and
wherein the sizing process reduces the size of the material to particles with no dimension larger than 30 cm, 20 cm, 10 cm, 5 cm, 2.5 cm, 1 cm, 0.5 cm, or 0.2 cm.

37. A process for producing valuable products by catalytically pyrolyzing polymeric hydrocarbonaceous materials, comprising:
contacting a stream comprising polymeric hydrocarbonaceous materials with a core-shell zeolite catalyst in a fluid bed catalytic reactor,
wherein the polymeric hydrocarbonaceous materials comprise at least 50% by mass plastics,
wherein the core-shell zeolite catalyst comprises catalyst particles comprising:
at least one core particle comprising a zeolite, and
a shell which encapsulates or covers at least a portion of the surface of the at least one core particle;
removing the core-shell zeolite catalyst from the fluid bed catalytic reactor and regenerating at least a portion of the removed catalyst by reaction with an oxygen-containing gas in a regenerator,
washing at least a portion of the oxidatively regenerated catalyst with an aqueous wash solution,
returning at least a portion of the oxidatively regenerated catalyst and the washed catalyst to the fluid bed catalytic reactor,
separating vapor products exiting the fluid bed catalytic reactor from solids in a solid-separating device, and
recovering paraffins, olefins, or aromatics or some combination thereof from the vapor products.

38-39. (canceled)

40. The process of claim 37 wherein the washed catalyst is contacted with Ca, Mg, or both Ca and Mg containing materials that form a portion of the shell of the catalyst before being returned to the fluid bed catalytic reactor.

41-45. (canceled)

46. The process of claim 37 wherein the catalyst wash process is conducted with countercurrent flow of catalyst and wash solution in one vessel, or in multiple vessels wherein the catalyst and wash solutions move between vessels in a counter current fashion.

47-50. (canceled)

51. The process of claim 37 wherein a portion of the oxidatively regenerated catalyst sent to the catalyst wash is from 0.1 to 10%, 1 to 50%, 2 to 40%, 5 to 35%, or 10 to 30%, or less than 50%, 25%, 10%, 5%, or less than 1%, by mass of the oxidatively regenerated catalyst.

52. (canceled)

53. The process of claim 1 wherein the catalyst particle comprises one core particle at least partially encapsulated by the shell, and the shell is from 0.01 to 100 microns in thickness.

54. A system for managing and preserving catalyst activity in a process for producing valuable products by catalytically pyrolyzing polymeric hydrocarbonaceous materials, comprising:
a pretreatment facility for removing impurities from a feed by washing the feed with a wash solution,
a fluid bed catalytic reactor comprising a core-shell catalyst,
wherein the core-shell catalyst comprises catalyst particles comprising:
at least one core particle comprising a zeolite, and
a shell which encapsulates or covers at least a portion of the surface of the at least one core particle,
contacting the stream comprising washed polymeric hydrocarbonaceous materials with the core-shell catalyst in the fluid bed catalytic reactor,
removing a portion of the core-shell catalyst from the fluid bed catalytic reactor to form a removed catalyst and oxidizing the removed catalyst with an oxygen-containing gas in a regenerator to form an oxidatively regenerated catalyst,
washing the oxidatively regenerated catalyst with an acidic aqueous wash solution to make a washed catalyst,
discarding a portion of the oxidatively regenerated catalyst, and
returning at least a portion of the washed catalyst to the fluid bed catalytic reactor, and optionally returning at least a portion of the oxidatively regenerated catalyst to the fluid bed catalytic reactor, and adding to the reactor a fresh, unregenerated portion of the catalyst, wherein the mass of the fresh, unregenerated portion of the catalyst is equal to or within 20% (or within 10% or within 5%) of the mass of the discarded portion of catalyst,
separating vapor products exiting the fluid bed catalytic reactor from solids in a solid-separating device,
recovering paraffins, olefins, or aromatics or some combination thereof from the vapor products; and
(a) wherein the shell has a thickness of from 0.01 to 100 microns (μm); or
(b) wherein the core-shell catalyst comprises a plurality of core particles dispersed in a matrix material wherein the matrix material comprises at least 5 mass % Ca.

55. The system of claim 54 wherein a sum of the masses of elements Ca, Mg, Sr, Ba, Li, Na, K, Rb, and Cs together constitute at least 5, 10, 25, 50, or 75, or from 1 to 75, 5 to 50, or 10 to 25% by mass of the shell.

56-64. (canceled)
